(19) United States
(12) Patent Application Publication
(10) Pub. No.: US 2025/0214542 A1
(43) Pub. Date: Jul. 3, 2025

(54) SENSOR CLEANING DEVICE, PNEUMATIC SYSTEM, VEHICLE, AND METHOD FOR OPERATING A SENSOR CLEANING DEVICE

(71) Applicant: ZF CV Systems Global GmbH, Bern (CH)

(72) Inventor: Jan-Christoph von der Beeke, Algermissen (DE)

(21) Appl. No.: 19/085,853

(22) Filed: Mar. 20, 2025

Related U.S. Application Data
(63) Continuation of application No. PCT/EP2023/073760, filed on Aug. 30, 2023.

(30) Foreign Application Priority Data
Sep. 29, 2022 (DE) 10 2022 125 110.1

(51) Int. Cl. B60S 1/56; B60S 1/50; B60S 1/52; B60S 1/54

(52) U.S. Cl. CPC B60S 1/56; B60S 1/50; B60S 1/52; B60S 1/54

(57) ABSTRACT

A sensor cleaning device is for a vehicle and configured for cleaning a sensor surface of a sensor. The sensor cleaning device includes: a pressurized-air inlet for receiving pressurized air, a liquid inlet for receiving liquid, a cleaning port for providing the liquid and/or the pressurized air. The sensor cleaning device has a conveyed-volume region, configured to accommodate the liquid, which is fluidically connected to the pressurized-air inlet, the liquid inlet and the cleaning port, such that the liquid is conveyed in a conveying direction to the cleaning port as a result of the pressurized air being applied to the pressurized-air inlet, wherein the conveyed-volume region is realized such that, for the purpose of conveying the liquid, the pressurized air is in contact with the liquid, in particular directly and/or in a pressure-transmitting manner realizing a phase boundary.

### CROSS-REFERENCE TO RELATED APPLICATIONS

This application is a continuation application of international patent application PCT/EP2023/073760, filed Aug. 30, 2023, designating the United States and claiming priority from German application 10 2022 125 110.1, filed Sep. 29, 2022, and the entire content of both applications is incorporated herein by reference.

### BACKGROUND

Sensor cleaning devices for vehicles are widely known. Via a sensor cleaning device, surfaces on a vehicle, in particular sensor surfaces of sensors, may be cleaned via at least one cleaning fluid, in particular a liquid and/or pressurized air.

By the cleaning of sensor surfaces on the vehicle, in particular performed regularly, it can be ensured that sensors become less soiled and therefore function more reliably. A clean sensor surface thus advantageously increases the reliability of driver assistance functions and/or semi-autonomous and/or autonomous driving functions of a vehicle. The safety of the vehicle, its occupants and other road users is thus advantageously increased by a sensor cleaning device.

Cleaning devices that, basically, are advantageously of this type already exist. For example, US 2019/0337490 describes a vehicle cleaning system, for cleaning an object that is to be cleaned, wherein the vehicle cleaning system is provided with a tank that accommodates a cleaning liquid, a pump that supplies the cleaning liquid under pressure inside the tank, a high-pressure air generation unit that generates high-pressure air, a first ejection port that sprays the cleaning liquid in the direction of a cleaning surface of the object that is to be cleaned, a second ejection port that sprays the high-pressure air in the direction of the cleaning surface, and a controller and a vehicle control ECU that control the spraying of the cleaning liquid and the spraying of the high-pressure air; and the controller and the vehicle control device perform control so as to initiate the spraying of the high-pressure air from the second ejection port after the spraying of the cleaning liquid from the first ejection port has been initiated.

DE 103 32 939 B4 also describes a device for cleaning a front region that is located in front of a distance sensor installed in a vehicle, in particular a commercial vehicle, wherein pressurized air, supplied via a line from at least one pressurized-air source present in the vehicle, can be applied to the front region, wherein the pressurized-air supply is controlled in dependence on certain time intervals during vehicle operation.

US 2021/0323510 and US 2022/0332290 describe a sensor cleaning device for selectively applying a first medium to a surface, having: a high-pressure storage vessel configured to store the first medium held under a storage pressure, a pulse nozzle, configured for applying the first medium under the storage pressure in a pulsed manner to the surface, a switching valve having a nozzle port and a high-pressure storage-vessel port, configured for selectively establishing a first connection between the high-pressure storage vessel and the pulse nozzle, and a feed port for establishing a second connection between the high-pressure storage vessel and a first medium source. In the case of the sensor cleaning device described therein, it is provided that the high-pressure storage vessel and the switching valve are structurally integrated in a storage-vessel valve module, wherein the switching valve is realized as a solenoid valve, to switch between the first and the second connection when the high-pressure storage-vessel port is under the storage pressure.

US 2022/0017047 describes a sensor cleaning system for cleaning sensors, in which a switching unit is configured in such a way that a sensor can be cleaned, via at least one nozzle line, with a cleaning liquid emerging from at least one nozzle and/or a cleaning gas emerging from at least one nozzle. The switching unit is instrumental here, and includes switching valves that can be controlled by a control unit. One embodiment provides for a gas storage vessel to be arranged in one container and a liquid storage vessel in another container. Arranged between the two containers there is storage line, via which the two containers are connected to each other. In this case, an additional switching unit between the containers is advantageous. A more compact embodiment of the sensor cleaning system may be achieved by accommodating the cleaning liquid and the cleaning gas in a common container. The cleaning liquid and the cleaning gas then directly adjoin each other. In this case, when the cleaning gas, which in particular is located above the cleaning fluid, is being pressurized, the cleaning liquid simultaneously becomes pressurized via the cleaning gas, such that ultimately the cleaning liquid and the cleaning gas are pressurized. It is then possible to dispense with a switching unit between the liquid storage vessel and the gas storage vessel. However, in order then for the cleaning liquid to be filled without pressure, the container must first be vented. The reason for this is that the containers of US 2022/0017047 are each realized as a storage vessel for holding the cleaning liquid and the cleaning gas.

Despite these basically advantageous approaches, sensor cleaning devices are still in need of improvement, in particular with regard to a structural configuration that is as simple as possible, and/or energy-efficient, effective sensor cleaning.

It would therefore be desirable to improve sensor cleaning devices, in particular with regard to a low apparatus complexity and/or efficient utilization of energy and/or cleaning fluids.

### SUMMARY

It is an object of the disclosure to provide an improved device and an improved method which, in particular, render possible a simplified structural configuration and/or improved efficiency with regard to the required cleaning fluids and/or the required energy. To be provided are a sensor cleaning device that is improved in this regard, a pneumatic system, a vehicle and a method for operating a sensor cleaning device.

The object relating to the sensor cleaning device is achieved by the disclosure, in a first aspect, with various embodiments of a sensor cleaning device for a vehicle.

The disclosure is based on a sensor cleaning device for a vehicle, configured for cleaning at least one sensor surface of a sensor, wherein the sensor cleaning device includes: a pressurized-air inlet configured for receiving pressurized air; a liquid inlet configured for receiving liquid, and a cleaning port configured for providing the liquid and/or the pressurized air.

Provided according to the disclosure in the case of the sensor cleaning device is a conveyed-volume region, which is configured to accommodate the liquid.

The conveyed-volume region is fluidically connected to the pressurized-air inlet, the liquid inlet and the cleaning port. In particular, the conveyed-volume region is formed as a part of a pneumatic connection.

The conveyed-volume region is fluidically connected to the pressurized-air inlet, the liquid inlet and the cleaning port in such a way that the liquid is conveyed in a conveying direction to the cleaning port as a result of the pressurized air being applied to the pressurized-air inlet, wherein the conveyed-volume region is realized in such a way that, for the purpose of conveying the liquid, the pressurized air is in contact with the liquid, in particular directly and/or in a pressure-transmitting manner realizing a phase boundary.

A pressure-transmitting contact may generally to that extent also be effected via a pneumatic means or a pneumatic actuator—this may preferably be, for example, a non-return valve.

Preferred, however, is a contacting of liquid and pressurized air that produces an immediacy—to that extent a direct, pressure-transmitting contact with the liquid; this may preferably be, for example, a diaphragm between the liquid and the pressurized air.

In a very particularly preferred embodiment, the pressure-transmitting contact of the pressurized air with the liquid is a contact with the liquid that realizes a phase boundary, that is, a situation where the pressurized air and the liquid are in direct contact without there being any separating medium between them. To that extent, this embodiment also establishes a direct pressure-transmitting contact realizing a phase boundary.

The disclosure is based on the knowledge that cleaning with liquids is fundamentally advantageous because, in this way, in particular, soiling can be softened and rinsed away. The disclosure includes the knowledge that a simple structural configuration of a sensor cleaning device is advantageous, as this enables savings in costs and weight in the vehicle. In particular, additional pumps and similar means for conveying liquid result in increased costs, weight and installation space, and increase the complexity and maintenance susceptibility of the sensor cleaning device.

The disclosure has unexpectedly recognized that, for conveying liquid for the purpose of cleaning, it is possible to dispense with a pump or similar conveying means if use is made of a conveyed-volume region that is realized in such a way that pressurized air for conveying the liquid is in direct, pressure-transmitted contact with the liquid.

This means that the conveyed-volume region is realized in such a way that the pressurized air provided at the pressurized-air inlet can contact the liquid and consequently transmit a pressure, in particular a conveying pressure, to the liquid.

To operate such a sensor cleaning device, therefore, in particular only a pressurized-air source and a liquid reservoir tank are required; the conveyed-volume region is formed, in particular and advantageously, distally from a storage region, downstream of a pneumatic separating means at the liquid inlet.

In particular, it may be sufficient if the liquid reservoir tank provides the liquid without pressure and/or guided by gravity, as the actual process of conveying to the cleaning port, or to a sensor surface to be cleaned, is effected by the application of pressurized air in the conveyed-volume region. The conveying direction leads from the liquid inlet, through the conveyed-volume region, to the cleaning port.

In the context of an embodiment, it is provided that the liquid inlet and/or the pressurized-air inlet and/or the cleaning port is/are arranged at or in the conveyed-volume region, preferably in a container wall. In other embodiments, the liquid inlet and/or the pressurized-air inlet and/or the cleaning port may be fluidically connected to the conveyed-volume region via a hose, a pipe or similar line. The conveyed-volume region itself may be formed, as it were, as part of a pneumatic connection, and in this sense may also be realized fluidically in accordance with the concept of the disclosure.

It is preferably provided that the conveyed-volume region is configured to accommodate a conveyed quantity of the liquid, wherein the conveyed quantity is conveyed to the cleaning port in a conveying direction as a result of the pressurized air being applied to the pressurized-air inlet.

It has proved to be advantageous, in particular, that there is a pneumatic separating means arranged at the liquid inlet of the conveyed-volume region. Particularly advantageously, the pneumatic separating means is in the comparatively simple form of an inlet non-return valve. The pneumatic separating means is advantageously configured to open in a conveying direction and to shut off counter to the conveying direction. Preferably, the sensor cleaning device includes an inlet non-return valve that is arranged at the liquid inlet and that opens in a conveying direction and shuts off counter to the conveying direction.

It has further proved advantageous for the conveyed-volume region to be pneumatically decoupled from a storage region, in particular from a liquid reservoir tank, by a pneumatic separating means at the liquid inlet, in particular an inlet non-return valve. Preferably, the conveyed-volume region is thus formed distally from the storage region, downstream of the separating means at the liquid inlet.

In particular, the aforementioned embodiments mean that a more or less “intelligent”-because automatic-filling of the conveyed-volume region may be effected. Refilling of the conveyed-volume region thus occurs automatically, for example immediately before and/or after a cleaning operation.

This has particular advantages with respect to the prior art cited at the outset, where possibly an entire storage vessel is pressurized. However, the conveyed-volume region according to the concept of the disclosure, and in particular according to one of the aforementioned embodiments, is advantageously formed so as to be pneumatically separated from a storage vessel; as only, as it were, a smaller partial volume that is required for cleaning and that can be pressurized appropriately and automatically for this purpose. The conveyed-volume region is formed, as it were, as part of a pneumatic connection, and in this sense is also fluidic according to the concept of the disclosure.

Preferably, the sensor cleaning device includes an outlet overflow valve that is arranged at the cleaning port and that opens in a conveying direction, preferably against an outlet spring force of a valve spring, and shuts off counter to the conveying direction. As the sensor cleaning device has an inlet non-return valve, and preferably, in addition, an outlet overflow valve, the principle of a sluice may be implemented in an advantageous manner. This means that liquid flows into the conveyed-volume region, in particular automatically via the inlet non-return valve, but does not flow back when pressurized air is subsequently applied at the pressurized-air inlet, due to the inlet non-return valve being shut off, and thus the conveyed quantity of liquid present in the conveyed-volume region is directed out of the conveyed-volume region in a constrained manner via the cleaning port. In other words, an inlet non-return valve prevents the liquid in the conveyed-volume region from flowing back into the liquid reservoir tank when pressurized air is applied to the pressurized-air inlet.

After the conveyed quantity has left the conveyed-volume region, then—as long as there is pressurized air still present at the pressurized-air inlet, and the inlet non-return valve thus shuts off—no more new liquid is provided at the cleaning port, but only pressurized air. It is thereby ensured that only a defined quantity, namely the conveyed quantity, of liquid is ever consumed for each cleaning operation, or each time pressurized air is applied to the pressurized-air inlet. This allows the quantity of liquid to be portioned independently of the quantity of pressurized air. Continuous application of pressurized air after the conveyed quantity has passed the cleaning port may also be used to automatically dry a sensor surface after the conveyed quantity of liquid has been directed onto the latter.

Preferably, the inlet non-return valve is configured to enable automatic filling of a conveyed-volume region with a conveyed quantity of a liquid from a liquid reservoir tank. Preferably, the inlet non-return valve is not spring-loaded. In other embodiments, the inlet non-return valve may have a liquid-inlet valve spring and thereby be spring-loaded with a defined liquid-inlet spring force.

With a spring-loaded inlet non-return valve, it can advantageously be achieved that, if the pressure of the liquid in the liquid reservoir tank falls below a minimum pressure, for example because the level of liquid in the liquid reservoir tank falls below a minimum fill height, no more liquid enters the conveyed-volume region automatically.

Preferably, however, in an alternative variant, the spring of the inlet non-return valve is set differently. The inlet non-return valve or similar pneumatic separating means is preferably spring-loaded in such a way that the spring opens it, even with a very low tank volume and thus also with low liquid pressure from the tank. It can thereby be achieved, advantageously, that even when the tank is almost empty, a residual quantity still passes through the valve, which normally remains open, into the conveyed-volume region. The valve would then only shut off when pressure is applied via the pressurized-air inlet—the pressurized air then also presses the non-return valve closed against its spring force; that is, the non-return valve is also shut off against its spring force under the action of the pressurized air.

Preferably, the liquid inlet and/or the inlet non-return valve is/are arranged in a lower region of the liquid reservoir tank. Preferably, the liquid inlet and/or the inlet non-return valve is/are arranged, in the direction of gravity, beneath the liquid reservoir tank. Preferably, the liquid inlet and/or the inlet non-return valve is/are fluidically connected to the liquid reservoir tank via a liquid supply line.

Various embodiments are characterized by an inlet overflow valve, which is arranged at the pressurized-air inlet, opens in a pressurization direction of the pressurized air and shuts off counter to the direction of pressurization, and is preferably spring-loaded. Such an inlet overflow valve advantageously ensures that pressurized air at the pressurized-air inlet is effective for the conveyed-volume region and for cleaning only when the conveying pressure of the pressurized air exceeds a minimum pressure in the form of an inlet overflow pressure. In this way, pressurized-air flows of a lower pressure, which are caused, for example, by certain venting processes and would not be sufficient for effective cleaning, or conveying of the liquid, in respect of their pressure level, may be disregarded.

In various embodiments, it is provided that the outlet overflow valve is spring-loaded and has an outlet-valve spring. A spring-loaded outlet overflow valve makes it possible, advantageously, to prevent liquid from accidentally emerging via the outlet overflow valve if the pressurized air is not being applied to the pressurized-air inlet.

It can preferably be provided that the outlet overflow valve and/or the inlet non-return valve and/or the inlet overflow valve is/are formed as a piston valve, preferably having an integrated spring element. Preferably, at least two of the outlet overflow valve and the inlet non-return valve and the inlet overflow valve are of identical construction, in order advantageously to reduce the complexity of the structural configuration of the sensor cleaning device.

In an embodiment, it is provided that the pressurized-air inlet has a shut-off valve seat, which can be closed by the inlet overflow valve in dependence on an inlet overflow-valve position, and pneumatically connected between the inlet overflow valve and the shut-off valve seat there is a pressure chamber, which is configured to accommodate a pressurized-air pulse quantity from the pressurized-air inlet when the inlet overflow valve is in an open inlet overflow-valve position, and to provide the pressurized-air pulse quantity, via the shut-off valve seat, to the conveyed-volume region when the overflow valve is in a closed overflow-valve position. Such an arrangement of a shut-off valve seat and a pressure chamber advantageously enables a pressurized-air pulse to be generated, even if a previously longer-lasting pressurized-air supply is terminated again at the pressurized-air inlet, in particular if it is no longer present. The pressurized-air pulse in the form of the pressurized-air pulse quantity is likewise advantageously transmitted in a pulse-type manner to the conveyed quantity, or the liquid, which is consequently provided in a pulse-type manner at the cleaning port, or at least at one cleaning nozzle. To that extent, it is advantageously provided that the actual cleaning begins only when the application of pressurized air is removed from the pressurized-air inlet; in other words, the actual cleaning begins with the opening of the shut-off valve seat.

Also, such an arrangement of a shut-off valve seat and a pressure chamber allows a pressurized-air pulse quantity always to be provided in a constant manner in respect of both its quantity and pressure, regardless of the conveying pressure and the duration of the application of pressurized to the pressurized-air inlet.

Additionally, this enables the working air of a pressurized-air consumer to be tapped in parallel, to serve as a pressurized-air source; this is possible because the configuration of the conveyed-volume region means that only a defined quantity of pressurized air (the pressurized-air pulse quantity) can flow in, and therefore the working pressurized air of the pressurized-air consumer does not flow out continuously via the sensor cleaning unit during its actuation.

Theoretically, therefore, the working air of the service brake could also be used for sensor cleaning, and cleaning could be initiated by actuating the brake. For this, it may preferably be provided that the inlet overflow valve opens only beyond a certain brake pressure. Advantageously, sensor cleaning may then be achieved by actuating the service brake above a minimum pressure.

An improved cleaning action effect may also be achieved via a pulse-type application to the sensor surface.

Various embodiments are characterized by a liquid reservoir tank, which is or can be fluidically connected to the liquid inlet. Preferably, the liquid reservoir tank and the sensor cleaning device may be realized in an integrated manner, particularly preferably in one piece.

In the context of an embodiment, it is provided that the conveyed-volume region is arranged in the liquid reservoir tank, or projecting into the liquid reservoir tank, preferably in such a way that the liquid inlet is arranged in a lower region of the liquid reservoir tank. In particular, the lower region is that part of the liquid reservoir tank that is located in the lower 20%, preferably in the lower 10%, particularly preferably in the lower 5% of the tank height, that is, a vertical extent, of the liquid reservoir tank.

The disclosure is further developed in that the pressurized-air inlet and/or a pressurized-air branch is/are arranged in or on the liquid reservoir tank, preferably in a tank wall, and the liquid inlet is arranged in or on the conveyed-volume region, preferably in a container wall.

Preferably, the conveyed-volume region includes an immersion tube, which extends into the liquid reservoir tank and which includes the liquid inlet, and a conveying passage, which is arranged outside of the liquid reservoir tank and which includes the pressurized-air inlet on a first side and the cleaning port on an opposite, second side, wherein the immersion tube is fluidically connected to the conveying passage at an immersion-tube port located between the first side and the second side. Particularly preferably, the immersion tube is arranged approximately in the direction of gravity, such that the liquid inlet is arranged in a lower region of the liquid reservoir tank. Particularly preferably, the conveying passage between the pressurized-air inlet and the immersion-tube port includes a pressurized-air branch that connects the conveying passage fluidically, in particular pneumatically, to the liquid reservoir tank, in particular to an upper region of the liquid reservoir tank. Particularly preferably, the upper region of the liquid reservoir tank has no liquid, that is, a maximum fill height of the liquid reservoir tank is below the upper region. Owing to the pressurized-air branch, pressurized air may advantageously be applied, at a conveying pressure present at the pressurized-air inlet, to the liquid in the liquid reservoir tank, which is thereupon conveyed through the liquid inlet and the immersion tube to the immersion-tube port. At the immersion-tube port, the liquid is in particular picked up by a throttle air flow and conveyed to the cleaning port. Particularly preferably, the conveying passage and/or the immersion-tube port is/are realized in such a way that, upon encounter with the throttle air flow, a spray mixture is formed, at the immersion-tube port, that is provided at the cleaning port for at least one cleaning nozzle. A spray mixture is a mixture of air with fine liquid, or water, droplets, which can thus advantageously be directed to the sensor surface via the cleaning nozzle.

In particular, the pressurized-air inlet and/or the pressurized-air branch is/are arranged in an upper region of the liquid reservoir tank. In particular, the upper region is that part of the liquid reservoir tank that is located in the upper 20%, preferably in the upper 10%, particularly preferably in the upper 5% of the tank height, that is, a vertical extent, of the liquid reservoir tank.

In various embodiments, it is provided that the pressurized-air inlet and/or the liquid inlet and/or the cleaning port is/are arranged at or in the conveyed-volume region.

In the context of an embodiment, it is provided that the pressurized-air inlet is arranged, with respect to the conveying direction and/or a longitudinal axis of the conveyed-volume region, at a conveying distance from the cleaning port. It is preferably provided that the pressurized-air inlet is arranged opposite to the cleaning port with respect to the conveyed-volume region and/or the conveying direction.

This means, in particular, that the greater the conveying distance, the greater also is the effective conveyed quantity of the liquid, preferably with a constant average cross-sectional area of the conveyed-volume region. It is also possible, additionally or alternatively, to adapt the cross-sectional area of the conveyed-volume region in order to alter the conveyed quantity.

In particular, the conveyed-volume region is of an elongate shape, in particular of an aspect ratio such that a ratio of the length, along the longitudinal axis, to an average diameter is greater than 5.

In the context of an embodiment, it is provided that the outlet overflow valve is spaced apart from the inlet non-return valve, at a conveying height, in the direction of gravity. This means, in particular, that the outlet overflow valve is arranged such that it is spaced apart, at a conveying height, in the direction of gravity beneath the inlet non-return valve. In this way, in particular, the capacity of the conveyed-volume region may be increased by a fraction that is automatically filled with liquid irrespective of the fill height of the liquid reservoir tank. Preferably, the conveyed-volume region is arranged substantially vertically, in particular with an approximately vertically arranged longitudinal axis. In particular, the sensor cleaning device includes a nozzle line, which particularly preferably is arranged at least partially parallel to the conveyed-volume region.

Preferably, the cleaning port is arranged above a maximum fill height of the liquid reservoir tank and/or of the conveyed-volume region. In such embodiments, it is advantageously possible to dispense with an outlet overflow valve.

In various embodiments, a solenoid switching valve, arranged at the pressurized-air inlet, is provided, which is configured for controllable pressurization of the pressurized-air inlet. The solenoid switching valve can particularly preferably be controlled electrically or electronically. Preferably, the solenoid switching valve is a valve of a further pressurized-air consumer in a pneumatic system of a vehicle, that is advantageously realized, entirely or partly, for providing pressurized air at the pressurized-air inlet of the sensor cleaning device.

Preferably, the solenoid switching valve is integrated into the sensor cleaning device, in particular in a housing of the sensor cleaning device, or fastened to, preferably flanged-mounted on, the housing.

In various embodiments, the sensor cleaning device has a fill-level sensor that is configured to determine a fill height of the liquid in the liquid reservoir tank and/or in the conveyed-volume region. Preferably, the fill-level sensor is arranged in the conveyed-volume region. A fill-level sensor arranged in the conveyed-volume region is advantageous, in particular, if the overflow valve is to be dispensed with. Preferably, the fill-level sensor and the solenoid switching valve are connected to an electronic control unit via a common, particularly preferably two-wire, electrical line. Preferably, the fill-level sensor includes an electrical element that is configured to change its resistance and/or its capacitance and/or its inductance in dependence on a fill height in the conveyed-volume region and/or in the liquid reservoir tank. Preferably, the electronic control unit is configured to determine such a change of the electric element of the fill-level sensor via electric test pulses, particularly preferably without activating the solenoid switching valve.

To achieve the aforementioned object in a second aspect, the disclosure provides a pneumatic system for a vehicle. A pneumatic system for a vehicle includes: a sensor cleaning device according to the first aspect of the disclosure, and at least one sensor having a sensor surface.

In an embodiment of the pneumatic system, the sensor cleaning device is or can be pneumatically connected to a pressurized-air source, preferably so as to be controllable via a solenoid switching valve.

In an embodiment of the pneumatic system, a pressurized-air consumer is provided. In particular, the pressurized-air consumer serves a primary purpose other than sensor cleaning.

Preferably, a vent port of the pressurized-air consumer is or can be pneumatically connected to the pressurized-air inlet for the purpose of receiving a vent pressurized air as pressurized air. In such embodiments of a pneumatic system, vent air, which would otherwise have been routed unused into the environment, may in particular be used to operate the sensor cleaning device. In particular, embodiments of such a pneumatic system may be realized without an additional solenoid switching valve, such that the sensor cleaning device is always operated when vent air is present.

Preferably, a working port of the pressurized-air consumer is or can be pneumatically connected to the pressurized-air inlet for the purpose of receiving, as pressurized air, a working pressurized air. In such embodiments of a pneumatic system, working pressurized air of the pressurized-air consumer may be used, preferably as an alternative or in addition to another use of the working pressurized air in the pressurized-air consumer.

Preferably, a reservoir port of a pressurized-air source, preferably of a pressurized-air storage vessel and/or a compressor, is or can be pneumatically connected to the pressurized-air inlet for the purpose of receiving, as pressurized air, a reservoir pressurized air. In such embodiments of a pneumatic system, there may be a solenoid switching valve arranged at the reservoir port for the purpose of controllably providing the reservoir pressurized air, and/or a compressor may be realized such that it can be controlled in dependence on an electrical switching signal.

Preferably, the pressurized-air consumer is an air suspension system having at least one air spring. Preferably, the pressurized-air consumer is a brake system, in particular a parking-brake system having at least one parking-brake cylinder, or a service-brake system having at least one service-brake cylinder. Preferably, the pressurized-air consumer is a pneumatic steering-axle lock or an immobilizer or a container locking system. Preferably, the pressurized-air consumer is a lift axle having at least one lifting bellows. Nevertheless, other pressurized-air consumers can be used in a pneumatic system according to the second aspect of the disclosure that has a sensor cleaning device according to the first aspect of the disclosure.

To achieve the aforementioned object in a third aspect, the disclosure provides a vehicle. The vehicle is preferably a commercial vehicle or a passenger car or a trailer. The vehicle comprises a sensor cleaning device according to the first aspect of the disclosure or a pneumatic system according to the second aspect of the disclosure.

To achieve the aforementioned object in a fourth aspect, the disclosure leads to a method. The method according to the disclosure for operating a sensor cleaning device according to the first aspect of the disclosure includes the steps:
automatically filling a conveyed-volume region with a liquid from a liquid reservoir tank, preferably via an inlet non-return valve;
pressurizing the liquid with a pressurized air, which is in pressure-transmitting contact with the liquid.

In particular, the pressure-transmitting contact is a direct contact between the pressurized air and the liquid. Additionally or alternatively, the pressure-transmitting contact realizes a phase boundary between the pressurized air and the liquid.

The method for operating the sensor cleaning device further includes the step:
providing the pressurized liquid at a cleaning port.

As a result of the pressurizing of the liquid with a pressurized air, which is in pressure-transmitting contact with the liquid, the pressurized liquid is provided at a cleaning port.

Additionally, in particular, the pressurized air is provided at the cleaning port. The pressurized air may preferably be provided subsequently or simultaneously at the cleaning port. If the pressurized air and the liquid are provided simultaneously, a spray mixture, of pressurized air and liquid, is preferably provided.

Preferably, the provision of the pressurized air at a cleaning port may be effected upon request by the vehicle driver or the system. Initiation of the cleaning process can thus be achieved particularly easily. For example, this may involve an action such as applying the brake to provide pressurized air, or release of pressurized air by the system.

In a preferred embodiment of the method, a conveyed quantity of the liquid is conveyed through the sensor cleaning device, such that the steps are realized as follows: automatically filling a conveyed-volume region with a conveyed quantity of a liquid from a liquid reservoir tank, preferably via an inlet non-return valve; pressurizing the conveyed quantity of the liquid with a pressurized air in a direct pressure-transmitting contact; thereby providing the pressurized conveyed quantity of the liquid, and preferably subsequently or simultaneously providing the pressurized air at a cleaning port.

In a preferred embodiment of the method, the following steps are provided: directing the liquid, preferably the conveyed quantity, and/or the pressurized air onto a sensor surface of a sensor; determining a wait period that elapses between the activating of a solenoid switching valve, for the controlled application of a pressurized air to the liquid, and an impingement upon the sensor surface, and/or determining an application period in which the liquid is applied to the sensor surface, preferably via the actual sensor to be cleaned, and determining a fill height of the liquid in the liquid reservoir tank and/or in the conveyed-volume region in dependence on the wait period and/or the application period. In such an embodiment, an indirect fill-level measurement may be effected without an additional fill-level sensor, in that the sensor to be cleaned measures how long it takes, following the activating, or switching, of the solenoid valve, for liquid to emerge through the cleaning nozzle and/or how much liquid emerges from the cleaning nozzle, that is, how long from the start of the emergence of the liquid.

In a preferred embodiment of the method, the following step is provided: controlling a pressurized-air consumer, preferably actuating the pressurized-air consumer, to provide a working pressurized air to the sensor cleaning device, preferably at a pressurized-air inlet of the sensor cleaning device, to pressurize the liquid. Preferably, actuating the pressurized-air consumer includes actuating a brake system, in particular a parking-brake system having at least one parking-brake cylinder, or a service-brake system having at least one service-brake cylinder, or a pneumatic steering-axle lock or an immobilizer or a container locking system, or a lift axle with at least one lifting bellows.

Preferably, actuating the pressurized-air consumer includes a full actuation, particularly preferably provision of a maximum amount of working pressurized air.

Thus, in a preferred embodiment, for example as a result of a (full) actuation of a pressurized-air consumer, a portion of its working air may be used as pressurized air of the cleaning system, or the cleaning may be triggered, for example, by full actuation of the brake, by (brief) activation of a lifting bellows of a lift axle, et cetera.

Cleaning can be initiated comparatively easily by simply “fully applying the brake”. In particular, it is evident that this can take place without further communication between a tractor vehicle and a trailer (truck/trailer) of the vehicle 1000, and that it can be conveniently controlled by the driver.

Technically, the brake pressure may theoretically be used, for example, directly as pressurized air or, alternatively, the brake pressure from the trailer may be sensed via an electronic brake system (EBS system). The latter could recognize the full application of the brake by the driver as a request, initiate a cleaning operation and, in turn, activate the corresponding pressurized-air valve that is connected to the pressurized-air inlet.

In a preferred embodiment of the method, the following step is provided: venting a pressurized-air consumer, preferably terminating an actuating of the pressurized-air consumer, to provide a vent pressurized air to the sensor cleaning device, preferably at a pressurized-air inlet of the sensor cleaning device, for the purpose of pressurizing the liquid. Preferably, venting the pressurized-air consumer includes venting a brake system, in particular a parking-brake system having at least one parking-brake cylinder, or a service-brake system having at least one service-brake cylinder, or a pneumatic steering-axle lock or an immobilizer or a container locking system, or a lift axle having at least one lifting bellows.

It is to be understood that the sensor cleaning device according to the first aspect of the disclosure, the pneumatic system according to the second aspect of the disclosure, the vehicle according to the third aspect of the disclosure and the method according to the fourth aspect of the disclosure have the same and similar sub-aspects. To that extent, for the embodiment of one aspect of the disclosure, reference is also made to the embodiments of the other aspects of the disclosure.

### BRIEF DESCRIPTION OF DRAWINGS

The invention will now be described with reference to the drawings wherein:

FIG. 1 shows a vehicle in the form of a trailer, having a sensor cleaning device according to the concept of the disclosure;

FIG. 2 shows a first embodiment of a sensor cleaning device according to the concept of the disclosure;

FIG. 2A shows the first embodiment of a sensor cleaning device in a non-actuated state according to the concept of the disclosure;

FIG. 2B shows the first embodiment of a sensor cleaning device in an actuated state according to the concept of the disclosure;

FIG. 3 shows a second embodiment of a sensor cleaning device in a first variant according to the concept of the disclosure;

FIG. 3A shows the second embodiment of a sensor cleaning device in a second variant according to the concept of the disclosure;

FIG. 3B shows the second embodiment of a sensor cleaning device in a third variant according to the concept of the disclosure;

FIG. 4A shows a third embodiment of a sensor cleaning device in an unactuated state according to the concept of the disclosure;

FIG. 4B shows a third embodiment of a sensor cleaning device in an actuated state according to the concept of the disclosure;

FIG. 5 shows a fourth embodiment of a sensor cleaning device according to the concept of the disclosure;

FIG. 6 shows a fifth embodiment of a sensor cleaning device according to the concept of the disclosure;

FIG. 7 shows a sixth embodiment of a sensor cleaning device according to the concept of the disclosure;

FIG. 8A shows a seventh embodiment of a sensor cleaning device according to the concept of the disclosure;

FIG. 8B shows an eighth embodiment of a sensor cleaning device according to the concept of the disclosure;

FIG. 8C shows, for a ninth and varied embodiment of a sensor cleaning device according to the concept of the disclosure, a first and second further variant of an inlet overflow valve in combination with the partly adapted pressure chamber and the conveyed-volume region, and otherwise same configuration of the eighth preferred embodiment according to FIG. 8B; and,

FIG. 9 shows a schematic representation of a pneumatic system with a pressurized-air consumer and a sensor cleaning device according to the concept of the disclosure.

### DETAILED DESCRIPTION

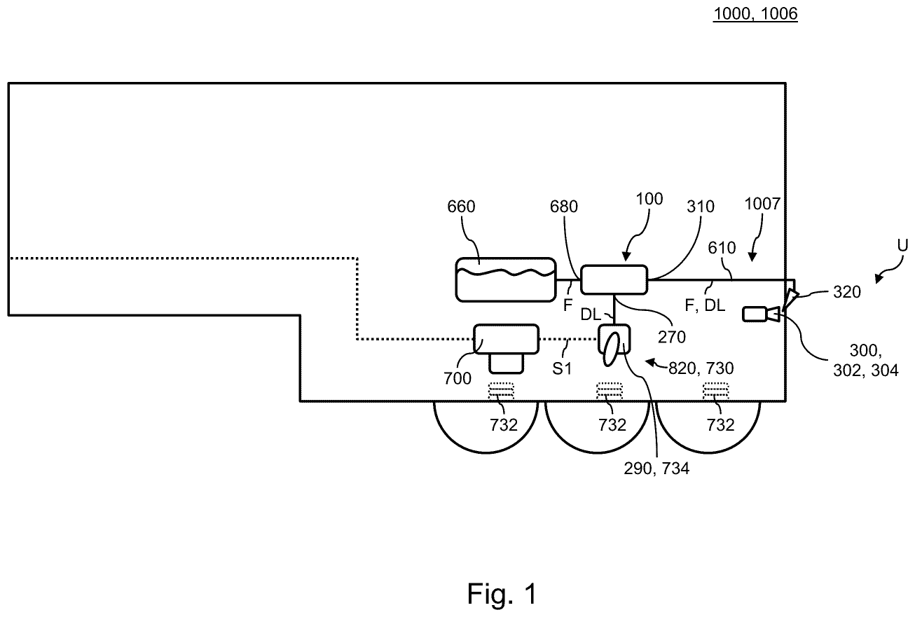

FIG. 1 shows a vehicle 1000, here in the form of a trailer 1006, in schematic form. The following description also applies analogously without restriction to any other type of vehicle 1000. However, due to the advantageously simple configuration of the sensor cleaning device described below, it is particularly advantageous for a trailer. Such a trailer 1006 is described below in a preferred embodiment.

The trailer 1006 has a sensor 300 having a sensor surface 301 in a rear region 1007 for sensing an environment U. The sensor 300 is realized here as an optical sensor 302 in the form of a camera 304. The trailer 1006 further has a cleaning nozzle 320 that is arranged and aligned in a fixed position in relation to the sensor surface 301 in such a way that it can apply liquid F and/or pressurized air DL to the sensor surface 301 for the purpose of cleaning. For this purpose, the cleaning nozzle 320 is fluidically connected to a cleaning port 310 of a sensor cleaning device 100 according to the concept of the disclosure. The sensor cleaning device 100 includes a liquid inlet 680, which is fluidically connected to a liquid reservoir tank 660. The liquid reservoir tank 660 may in embodiments also be realized as a central washing-water tank of a vehicle 1000, and thus serve as a reservoir for further cleaning means of the vehicle 1000. The liquid F may in particular be water, or a liquid containing cleaning additives.

The sensor cleaning device 100 includes a pressurized-air inlet 270, which in the present case is pneumatically connected to a pressurized-air consumer 820 of a pneumatic system 800 of the vehicle 1000. The pneumatic system 800 in the present case includes an air suspension system 730 having a number of air springs 732, which here are represented schematically. The trailer 1006 in the present case includes a solenoid switching valve 290, in the form of an electronically switchable air-spring valve 734 of the air suspension system 730. Via the electronically controllable solenoid switching valve 290, pressurized air may be provided in a controllable manner at the pressurized-air inlet 270 from a pressurized-air source, not represented in more detail here, in dependence on an electronic switching signal S1. In the present case, the electronic switching signal S1 is provided by an electronic control unit 700.

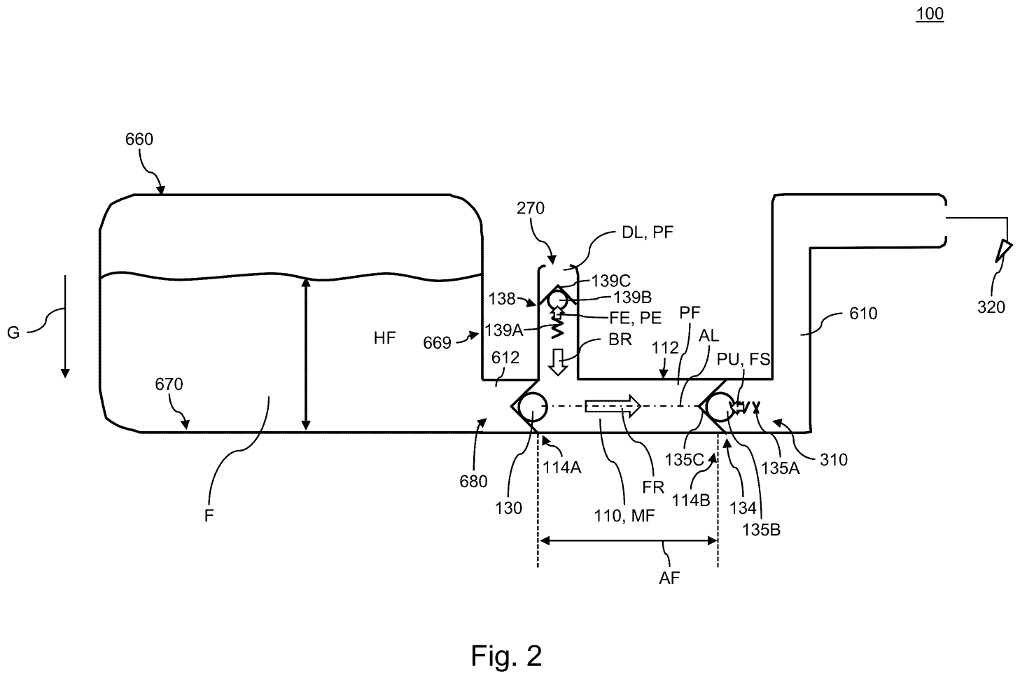

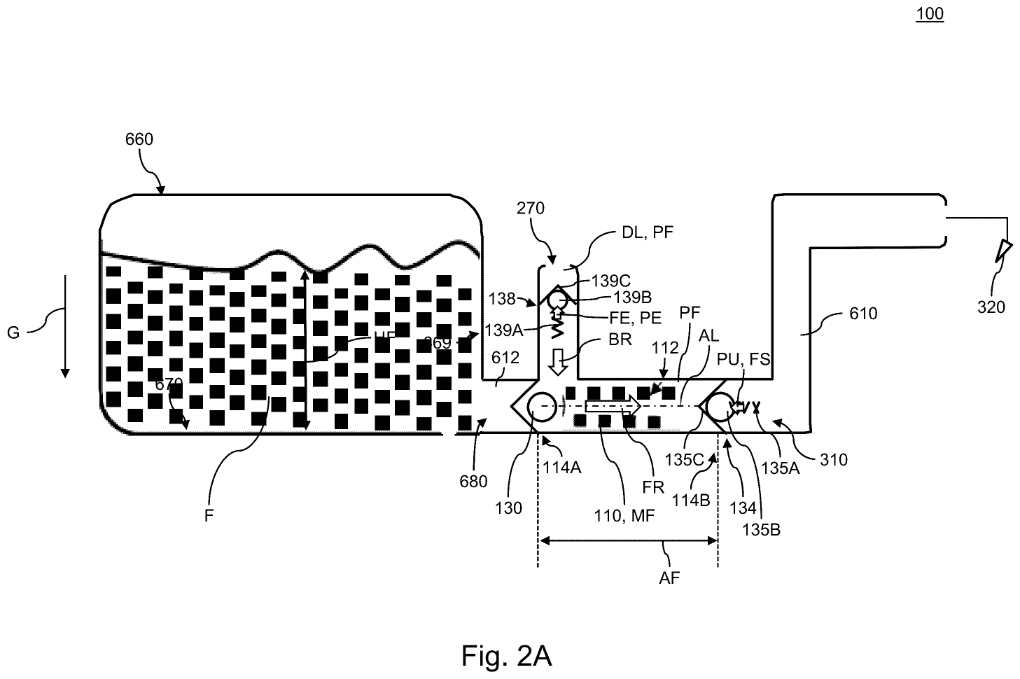

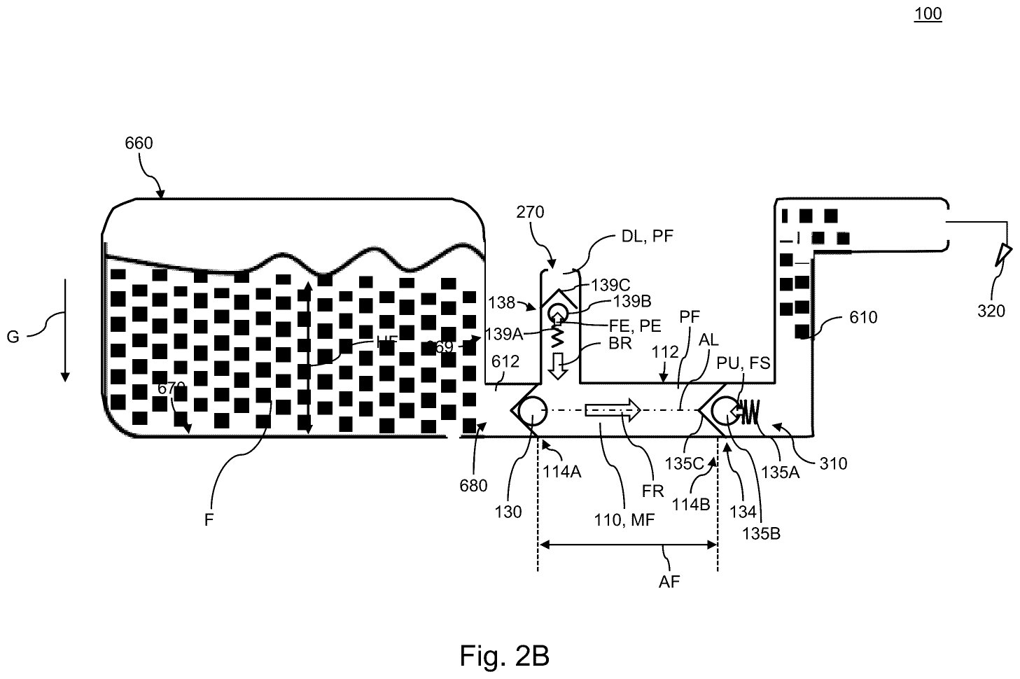

FIG. 2 shows a first preferred embodiment of a sensor cleaning device 100 according to the concept of the disclosure. The sensor cleaning device 100 includes a conveyed-volume region 110, which is configured to accommodate a conveyed quantity MF of a liquid F. The conveyed-volume region 110 includes a container wall 112, which encloses a defined volume for accommodating a conveyed quantity MF of the liquid F; this container wall 112 may be realized, for example, as part of a pneumatic connection. The conveyed-volume region 110 has a liquid inlet 680 for receiving the liquid F from a liquid reservoir tank 660. There is an inlet non-return valve 130 or similar pneumatic separation means arranged at the liquid inlet 680.

In the case of the present embodiment, care is thus taken in particular to ensure that the conveyed-volume region 110 is pneumatically decoupled from a storage region, in particular from a liquid reservoir tank 660, by a pneumatic separating means at the liquid inlet 680, in particular an inlet non-return valve 130. Nevertheless, in the present case, additionally a storage region, in particular a liquid reservoir tank 660, is or can be fluidically connected to the liquid inlet 680.

The conveyed-volume region 110 is thus formed distally from the storage region, downstream of the pneumatic separating means at the liquid inlet 680.

The inlet non-return valve 130 is realized in such a way that it opens in a conveying direction FR and shuts off counter to the conveying direction FR, the conveying direction FR extending from the liquid reservoir tank 660, via the conveyed-volume region 110, to the cleaning port 310. This means that liquid F flowing in the direction of the conveying direction FR can pass the inlet non-return valve 130 and thus flow from the liquid reservoir tank 660 into the conveyed-volume region 110. However, it is not possible for the liquid F to flow from the conveyed-volume region 110 into the liquid reservoir tank 660.

In the present case, the liquid inlet 680 and the conveyed-volume region 110 are arranged, with respect to a gravity G and a tank height HT, in a lower region 670 of the liquid reservoir tank 660, which advantageously enables liquid F to continue to flow automatically into the conveyed-volume region 110. The liquid reservoir tank 660 may be connected to the conveyed-volume region 110 directly, as shown here, or via a relatively short liquid supply line 612. The liquid supply line 612 leads into the liquid reservoir tank 660 at an opening in a tank wall 669 of the liquid reservoir tank. In other embodiments, it is nevertheless possible for the liquid reservoir tank 660 to be arranged at a distance from the conveyed-volume region 110 in the vehicle 1000 via a liquid supply line 612 of correspondingly longer dimensions.

The conveyed-volume region 110 further includes the cleaning port 310, which is fluidically connected to a cleaning nozzle 320 via a nozzle line 610. There is an outlet overflow valve 134, having an outlet valve spring 135A and an outlet valve body 135B, arranged at the cleaning port 310. The outlet overflow valve 134 is configured to open in a conveying direction FR against an outlet spring force FS, which is dependent on the outlet valve spring 135A, and to shut off counter to the conveying direction FR. If a conveying pressure PF in the conveyed-volume region 110 exceeds an outlet overflow pressure PU, the outlet valve body 135B lifts from an outlet valve seat 135C of the outlet overflow valve 134 and thus allows the liquid F and/or the pressurized air DL to pass from the conveyed-volume region 110 in the direction of the nozzle line 610 and the cleaning nozzle 320. It is not possible for pressurized air DL and/or liquid F to pass counter to the conveying direction FR, that is, from the nozzle line 610 into the conveyed-volume region 110, because the outlet overflow valve 134 then shuts off. However, if the conveying pressure PF is not present or is only low, the outlet overflow valve prevents the cleaning liquid from flowing out.

The conveyed-volume region 110 further includes a pressurized-air inlet 270, which is configured to receive pressurized air DL. Arranged at the pressurized-air inlet 270 there is an inlet overflow valve 138 that has an inlet valve spring 139A and an inlet valve body 139B. The inlet overflow valve 138 is configured to open in a pressurization direction BR, that is, in a direction into the conveyed-volume region 110, against an inlet spring force FE that is dependent on the inlet valve spring 139, and to shut off counter to the pressurization direction BR.

If a pressure applied at the pressurized-air inlet 270, in particular the conveying pressure PF, exceeds an inlet overflow pressure PE, the inlet valve body 139B lifts from an inlet valve seat 139C of the inlet overflow valve 138, and thus enables the pressurized air DL to flow from the pressurized-air inlet 270 into the conveyed-volume region 110. Due to the inlet overflow valve 138, a leakage of liquid F via the pressurized-air inlet 270 is advantageously avoided, even if a fill height HF of the liquid reservoir tank 660 extends beyond the position of the pressurized-air inlet 270 with respect to the direction of gravity G.

In the present case, the conveyed-volume region 110 has a container wall 112 that encloses an elongate, approximately cylindrical space that extends along a longitudinal axis AL. Nevertheless, in other embodiments, the conveyed-volume region 110 may be of a different, non-cylindrical shape. The liquid inlet 680 and the pressurized-air inlet 270 are arranged at a first end 114A of the cylinder, or of the conveyed-volume region. The cleaning port 310 is arranged at a second end 114B that is opposite to the first end 114A and at a conveying distance AF therefrom.

The sensor cleaning device 100 can advantageously be controlled by applying pressurized air DL to the pressurized-air inlet 270.

FIG. 2A now shows the first preferred embodiment of a sensor cleaning device in a non-actuated state according to the concept of the disclosure.

Present in the conveyed-volume region 110 is liquid F of the conveyed quantity MF, which arrives there automatically from the liquid reservoir tank 660 by the action of gravity G via the liquid inlet 680 and the inlet non-return valve 130. In the sensor cleaning device 100 shown in FIG. 2A, the inlet overflow valve 138 is closed in the non-actuated state; that is, it shuts off under the predominant action of the inlet valve spring 139A and the inlet overflow pressure PE.

If a pressurized air DL is now applied to the pressurized-air inlet 270 at a conveying pressure PF that is greater than the inlet overflow pressure PE, the inlet overflow valve 138 opens. FIG. 2B shows, correspondingly, the first preferred embodiment of a sensor cleaning device 100 in an actuated state according to the concept of the disclosure; that is, the inlet valve body 139B is lifted off the inlet valve seat 139C of the inlet overflow valve 138.

The pressurized air DL in this case comes into direct contact with the liquid F of the conveyed quantity MF in the conveyed-volume region 110 and acts upon it. Thus, the conveying pressure PF acts upon the liquid F of the conveyed quantity MF in the conveyed-volume region 110. As a result, the liquid F of the conveyed quantity MF, subjected to the conveying pressure PF, acts against the outlet overflow valve 134, which opens against the outlet spring force FS.

The inlet non-return valve 130 shuts off against the liquid F of the conveyed quantity MF that is subjected to the conveying pressure PF. Consequently, the conveyed quantity MF of the liquid F is directed, via the outlet overflow valve 134 and the nozzle line 610, to the cleaning nozzle 320, and from there further to a sensor surface 31, which is not represented here.

The duration of the application of pressurized air DL may advantageously be set, in particular via the corresponding controller of a solenoid switching valve 290 pneumatically connected to the pressurized-air inlet 270 and not represented here, in such a way that the application of pressurized air DL is continued when the conveyed quantity MF has left the conveyed-volume region 110. As a result, after the liquid F has been conveyed, pressurized air DL is further directed to the sensor surface 310 via the conveyed-volume region 110, the outlet overflow valve 134 and the cleaning nozzle 320, as a result of which the liquid F is dried and/or removed from the sensor surface 310.

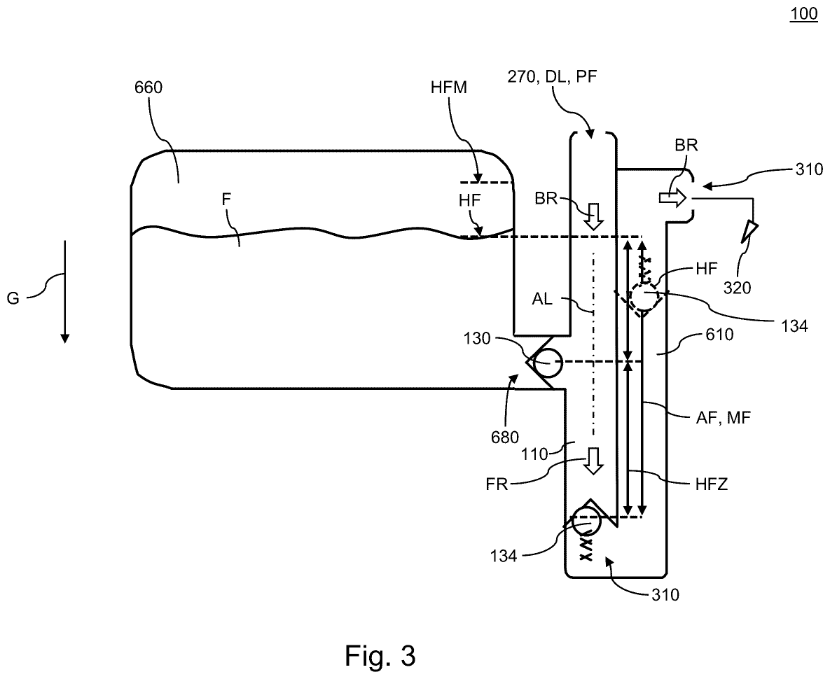

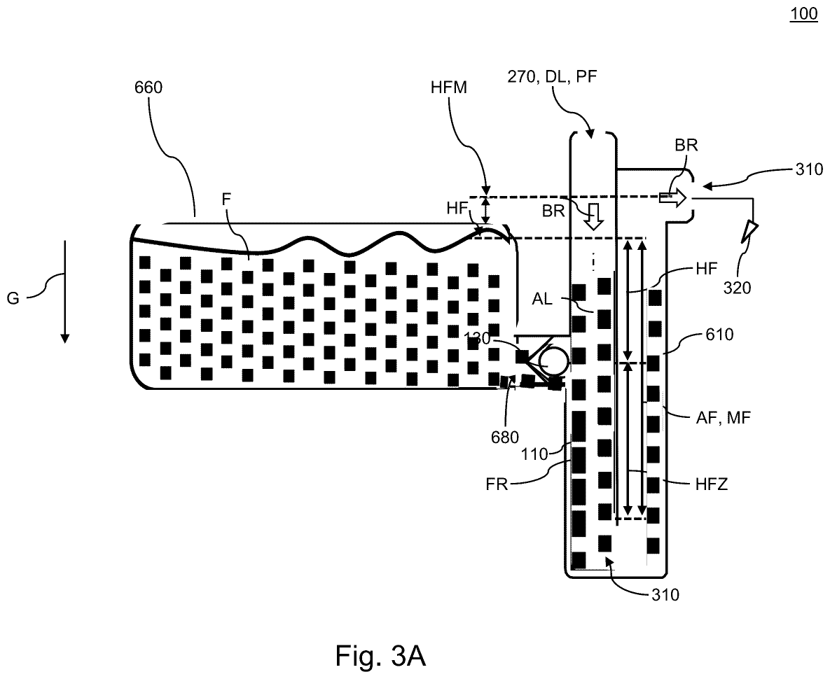

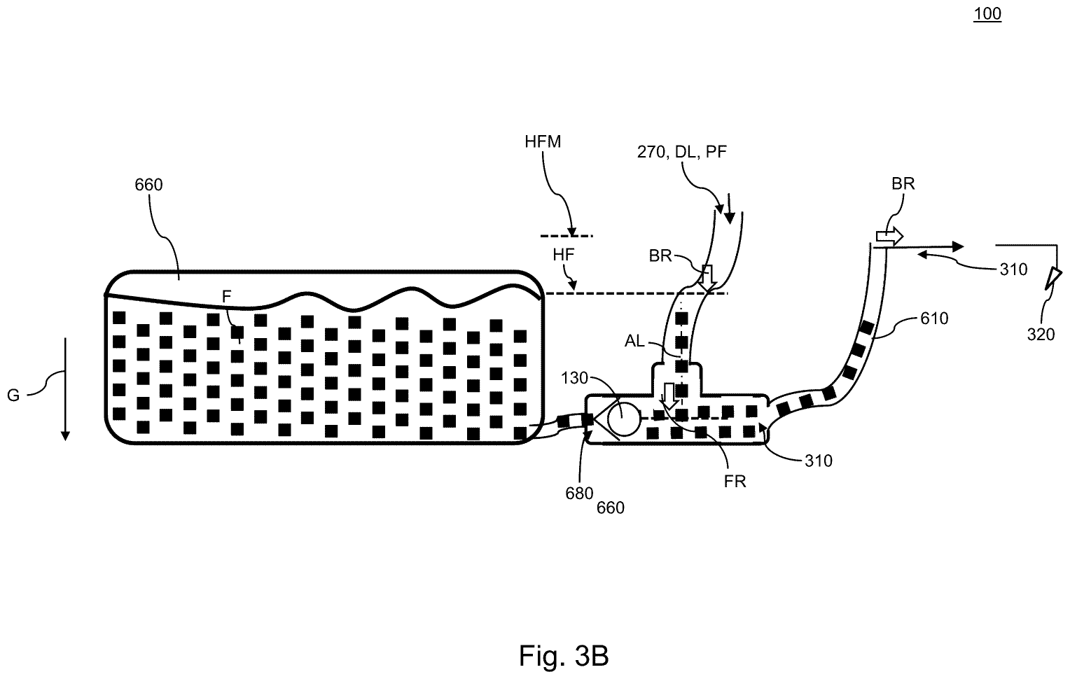

Shown in FIG. 3 is a second preferred embodiment of a sensor cleaning device 100 according to the concept of the disclosure. In contrast to the first embodiment shown in FIG. 2, the sensor cleaning device 100 shown here does not include an inlet overflow valve 138 at the pressurized-air inlet 270.

Instead, the pressurized-air inlet 270 is arranged with respect to the liquid reservoir tank 660 such that a maximum fill height HFM of the liquid reservoir tank 660, with respect to the direction of gravity G, is always below the pressurized-air inlet 270.

The outlet overflow valve 134 may also be arranged closer to the cleaning port 310 or formed with it; this can be seen from the additional or alternative outlet overflow valve 134 indicated by dashed lines in FIG. 3. In principle, it is also possible to dispense with the outlet overflow valve 134 as such, or the outlet overflow valve 134 as a separate valve. Accordingly, FIG. 3A shows the second preferred embodiment of a sensor cleaning device in a second variant according to the concept of the disclosure without the inlet overflow valve 138 at the pressurized-air inlet 270 and without the aforementioned outlet overflow valve 134 as such, in particular without the outlet overflow valve 134 as a separate valve. The embodiment shows a construction on the tank, or an embodiment of the conveyed-volume region 110 with inlet/outlet openings above the liquid reservoir tank 660; this makes it possible to configure the embodiment represented in FIG. 3A now only with the conveyed-volume region 110 and the inlet non-return valve 130. The elimination of outlet overflow valve 134 and inlet overflow valve 138 is made possible if the pressurized-air inlet 270 and the cleaning port 310, or their respective inflow/outflow lines, are arranged above the liquid fill height of liquid reservoir tank 660, preferably above the top edge of liquid reservoir tank 660.

As a further difference with respect to the first embodiment shown in FIG. 2, in the present case the conveyed-volume region 110 is orientated substantially vertically. This means that the longitudinal axis AL of the conveyed-volume region 110 extends substantially in the direction of gravity G. The conveyed quantity MF in the present case depends on the actual fill height HF of the liquid F in the liquid reservoir tank 660, since the conveyed-volume region 110 is likewise filled with liquid F up to this fill height HF. This is the case, in particular, because the sensor cleaning device 100 does not have an inlet overflow valve 138 that delimits the liquid F. The conveying length AF, which together with a cross-sectional area AQ of the conveyed-volume region 110 defines the conveyed quantity MF, is composed in the present case of the fill height HF and a conveying height HFZ, the conveying height HFZ being a distance, extending in the direction of gravity G, between the liquid inlet 680 and the cleaning port 310 arranged beneath the liquid inlet 680.

FIG. 3B shows the second preferred embodiment of a sensor cleaning device in a third variant according to the concept of the disclosure. In the construction shown therein, the single inlet non-return valve 130 is arranged at the level of the base of the liquid reservoir tank 660, or arranged beneath it with inflow/outflow lines extending above the upper edge of the tank. This offers the advantage that a cleaning liquid cannot leak out accidentally.

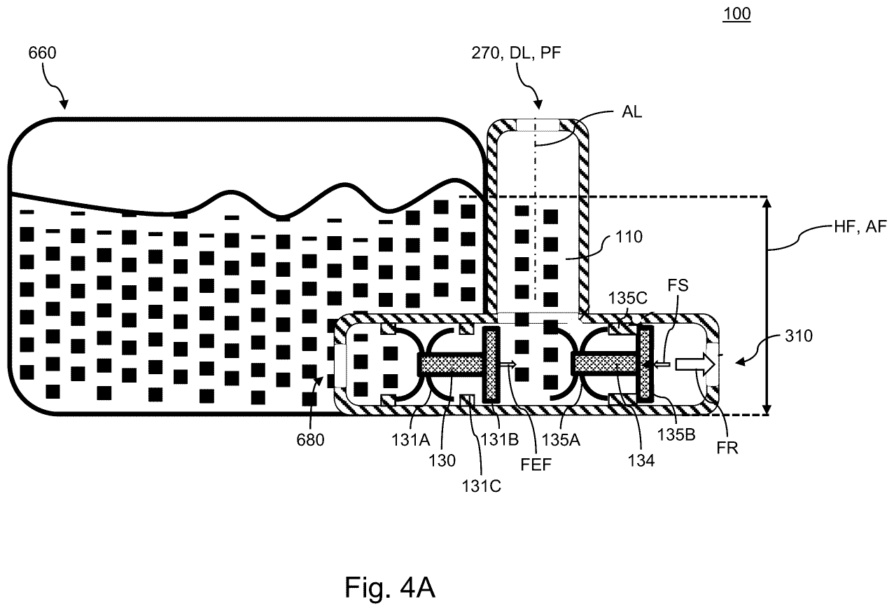

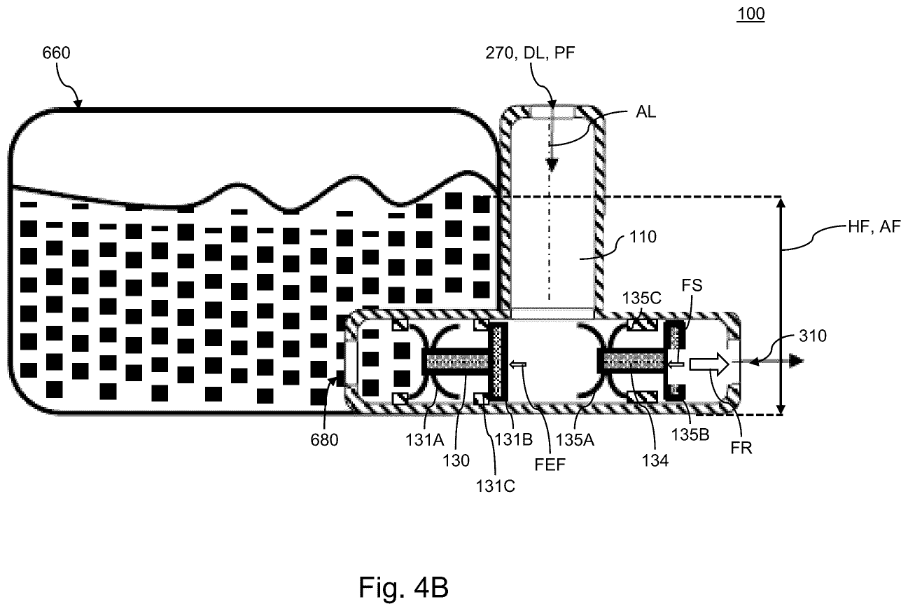

FIG. 4A shows a third preferred embodiment of a sensor cleaning device 100 in an unactuated state. This embodiment—like the second embodiment shown in FIG. 3 and FIG. 3A, FIG. 3B—has a conveyed-volume region 110 that extends in the direction of gravity G, that is, the longitudinal axis AL of the conveyed-volume region 110 is substantially parallel to the direction of gravity G. The conveying length AF substantially corresponds to the fill height HF of the liquid reservoir tank 660.

The inlet non-return valve 130 is of the same structural configuration as the inlet overflow valve 134, and consequently has a liquid-inlet valve spring 131A, a liquid-inlet valve body 131B and a liquid-inlet valve seat 131C. The inlet non-return valve 130 is accordingly configured to actively open in a conveying direction FR as a result of a liquid- inlet spring force FEF, such that the state of the liquid F in the conveyed quantity MF shown in FIG. 4A is attained (as explained with reference to FIG. 2, FIG. 2A). The inlet non-return valve 130 is correspondingly configured to shut off counter to the conveying direction FR. In the present case, the outlet valve spring 135A and the liquid-inlet valve spring 131A are realized with flexible spring elements.

In the present third embodiment, the inlet non-return valve 130 is substantially of the same structural configuration as the inlet overflow valve 134. This makes it possible, advantageously, to achieve a further reduction in the complexity of the sensor cleaning device 100. Consequently, the outlet overflow valve 134 has an outlet valve body 135B, which is held against an outlet valve seat 135C by an outlet valve spring 135A. The outlet overflow valve 134 is configured, in a manner similar to the embodiment shown in FIG. 2B, to shut off counter to the conveying direction FR. In particular, the outlet overflow valve 134 is configured, in a manner similar to the embodiment shown in FIG. 2B, to open in a conveying direction FR against an outlet spring force FS. FIG. 4B shows, correspondingly, the third preferred embodiment of a sensor cleaning device in an actuated state according to the concept of the disclosure.

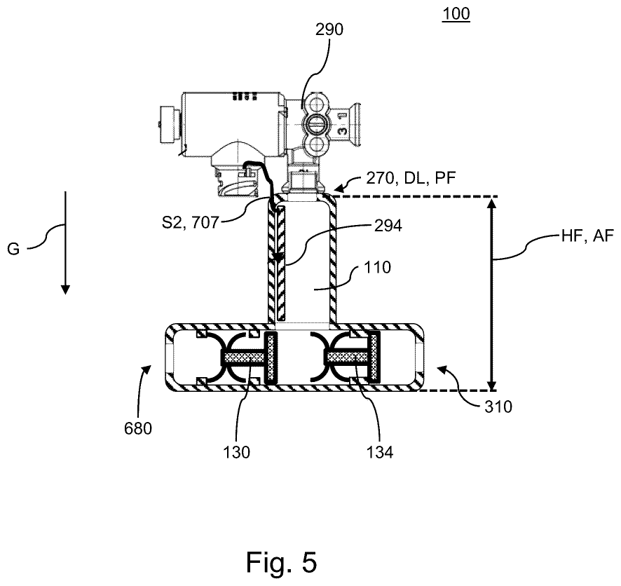

FIG. 5 shows a fourth preferred embodiment of a sensor cleaning device 100. The sensor cleaning device 100 substantially corresponds to the third embodiment shown in FIG. 4A, FIG. 4B, with the difference that the liquid reservoir tank 660 is not integrated on, or integrally connected to, the sensor cleaning device 100. Rather, in the case of the embodiment shown here, it is possible for the sensor cleaning device 100 to be arranged remotely from the liquid reservoir tank 660. In particular, the liquid inlet 680 of the sensor cleaning device 100 may be fluidically connected to the liquid reservoir tank 660 via a liquid supply line 612, which is not represented here.

Furthermore, represented in FIG. 5 is an electrically controllable solenoid switching valve 290 arranged at the pressurized-air inlet 270. The solenoid switching valve 290 is configured to provide pressurized air DL at the pressurized-air inlet 270 in a controllable manner.

The sensor cleaning device 100 further includes a fill-level sensor 294, which is arranged in the conveyed-volume region 110 and which is configured to determine a fill level, in particular the fill height HF, of the liquid F accommodated in the conveyed- volume region 110, and to provide a corresponding fill-level signal S2, in particular one that develops with the fill height HF, for example a proportional, preferably electrical signal, in dependence on the determined fill height HF. In the present case, the solenoid switching valve 290 is connected to the fill-level sensor 294 in respect of signal transmission via an electric line 707 for the purpose of receiving the electrical level signal S2.

Preferably, the solenoid switching valve 290, or an electrical or electronic control unit 700 connected thereto in respect of signal transmission, is configured to provide pressurized air DL at the pressurized-air inlet 270 when the fill height HF is sufficiently high, in particular by providing an electronic switching signal S1, and/or to terminate the provision of the pressurized air DL when the fill height HF is sufficiently low, in particular by terminating the provision of the electronic switching signal S1.

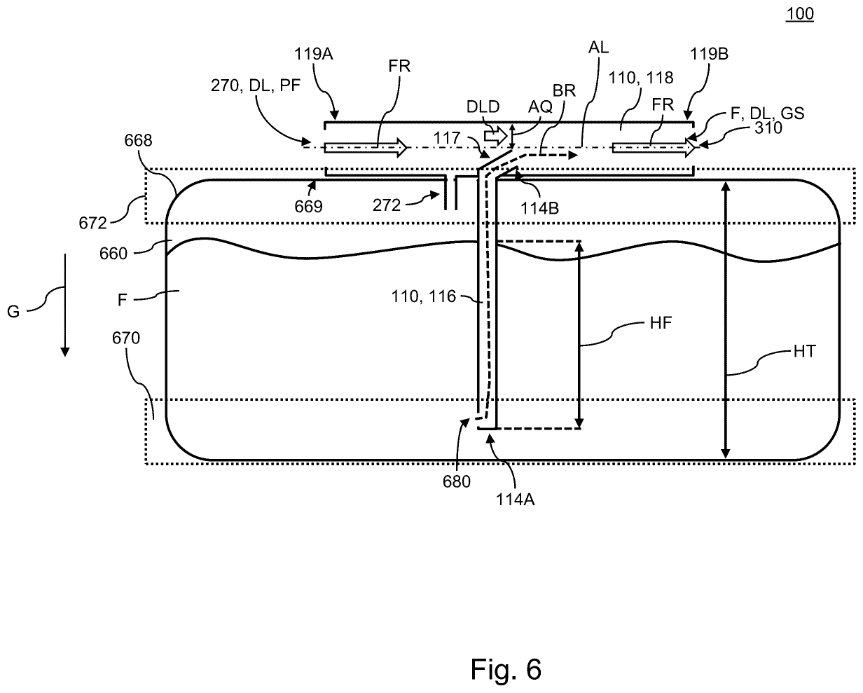

Represented in FIG. 6 is a further, fifth preferred embodiment of a sensor cleaning device 100. In contrast to the first to fourth embodiments shown in FIG. 2 to FIG. 5, the embodiment shown here is not based on the principle of a sluice having an inlet non-return valve and an inlet overflow valve. In the present case, the conveyed-volume region 110 includes an immersion tube 116 projecting downward into the liquid reservoir tank 660 in the direction of gravity G. The liquid inlet 680 is arranged at a first end 114A located at the bottom in the direction of gravity G. The liquid inlet 680 is arranged in a lower region 670 of the liquid reservoir tank 660. At a second end 114 B of the immersion tube 116 that is opposite to the first end face 114A, the immersion tube 116 is fluidically connected to a conveying passage 118 of the conveyed-volume region 110.

The conveying passage 118 is also elongate along a longitudinal axis AL, there being a pressurized-air inlet 270 arranged on a first side 119A, and a cleaning port 310 is arranged on an opposite, second side 119B. Consequently, a conveying direction FR extends from the first side 119A to the second side 119B.

Arranged in the conveying passage 118, between the first side 119A, that is, the pressurized-air inlet 270, and the second side 119B, that is, the cleaning port 310, there is an immersion tube port 117, via which the immersion tube 116 is fluidically connected to the conveying passage 118. In the present case, the immersion tube port 117 is in the form of a pipe socket curved in the conveying direction FR, causing liquid F conveyed into the conveying passage 118 via the immersion tube 116 to be accelerated in the direction of the cleaning port 310. The immersion tube port 117 projects into the conveying passage 118 and thus induces a throttling effect upon a passing throttling air flow DLD due to the resulting reduction of the cross section of the conveying passage 118 to a throttling cross section AQ.

Arranged between the first side 119A, that is, the pressurized-air inlet 270, and the immersion tube port 117 there is a pressurized-air branch 272. The pressurized-air branch 272 fluidically connects the conveying passage 118 to an upper region 672 of the liquid reservoir tank 660. In this way, a conveying pressure PF of the pressurized air DL provided at the pressurized-air inlet 270 may be transmitted to the liquid F in the liquid reservoir tank 660. As a result, the liquid F subjected to the conveying pressure PF is directed, via the liquid inlet 680 and the immersion tube 116, and further via the immersion tube port 117, to the cleaning port 310, where it is provided for a cleaning nozzle 320, which is not represented here.

With the embodiment represented here, it is also advantageously possible for the liquid F and the pressurized air DL to be provided as a spray mixture GS. Production of a spray mixture GS may advantageously be achieved by the configuration of the sensor cleaning device 100, in particular of a conveying pressure PF and/or a throttle cross section AQ.

In particular, due to the fact that, in the embodiment represented, no inlet non-return valve is provided, continuous conveying, in particular as a spray mixture GS, is possible over the duration of an application of pressurized air DL to the pressurized-air inlet 270, via the sensor cleaning device 100 represented.

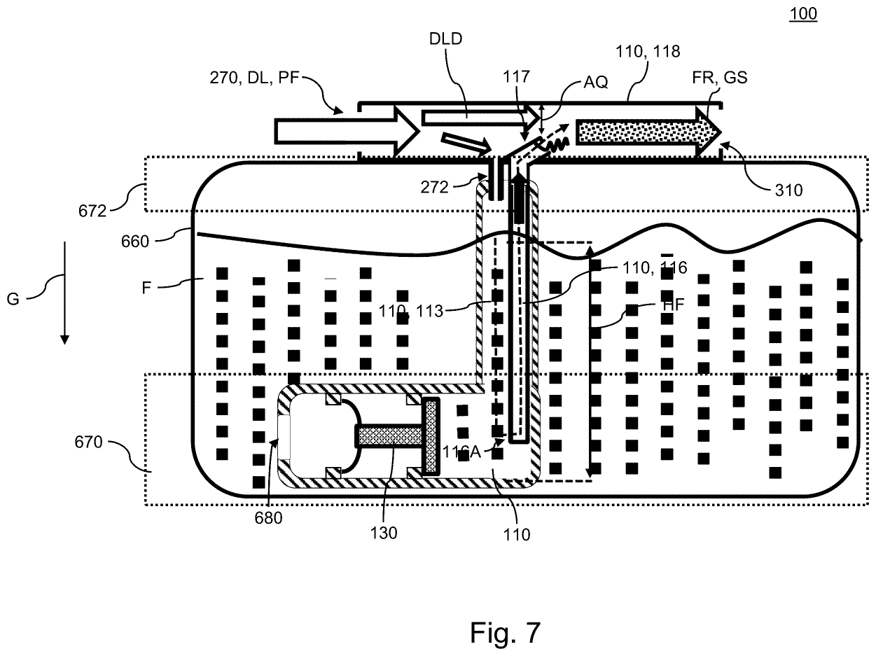

Shown in FIG. 7 is a sixth preferred embodiment of a sensor cleaning device 100. In contrast to the embodiment shown in FIG. 6, the sensor cleaning device 100 shown here has an inlet non-return valve 130, arranged at the liquid inlet 680 of the conveyed-volume region 110. The inlet non-return valve 130 encloses, in the conveyed-volume region 110, a conveyed quantity MF of liquid F that is provided at the cleaning port 310 as a result of pressurized air DL being applied to the pressurized-air inlet 270. As a result of the coupling of the immersion tube 116, via the immersion tube port 117, in the conveying passage 118, and thus the provision of the liquid F with mixing with a throttling air flow DLD directed through the throttle cross section AQ to form a spray mixture GS. Further, in addition to the conveying passage 118 and the immersion tube 116, the conveyed-volume region 110 further includes a conveying chamber 113 that connects the pressurized-air branch 272 to the immersion tube 116, namely to an immersion-tube orifice 116A arranged in the lower region 670 of the liquid reservoir tank 660, and thus shields it from the rest of the liquid tank 660. Liquid F from the liquid reservoir tank 660 can thus enter the conveyed-volume region 110 exclusively via the inlet non-return valve 130. In particular, a defined conveyed quantity MF may be conveyed via application of pressurized air DL. This is because, when pressurized air DL is applied to the pressurized-air inlet 270, and thus to the pressurized air branch 272, the inlet non-return valve 130 is shut off, as a result of which no liquid F can continue to flow during provision at the cleaning port 310. The conveyed quantity MF is therefore the liquid F held by the immersion tube 116 up to the fill height HF, and additionally the liquid F held by the conveying chamber 113 up to the fill height HF. It is only after pressurized air DL has been applied, that is, when there is no more conveying pressure PF at the pressurized-air port 270, that the inlet non-return valve 130 can open again, and cleaning liquid F can continue to flow into the conveyed-volume region 110.

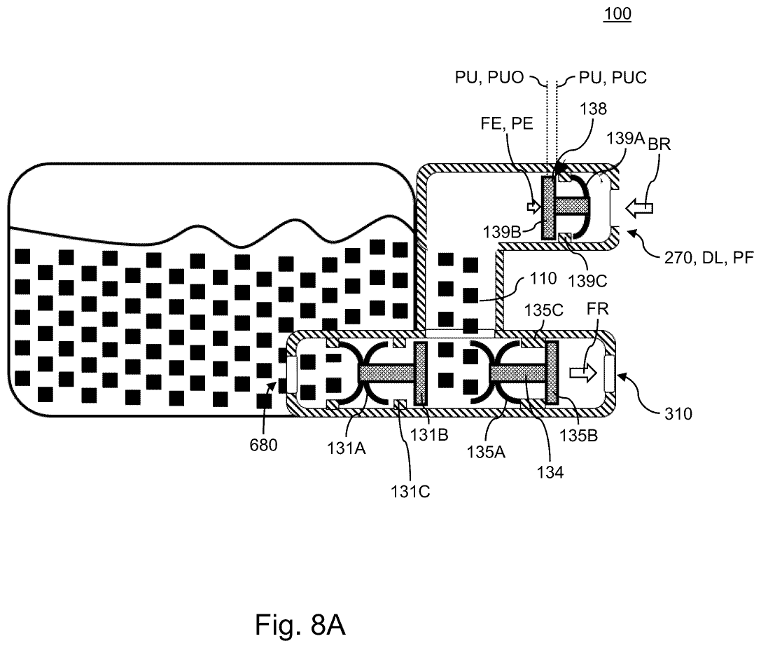

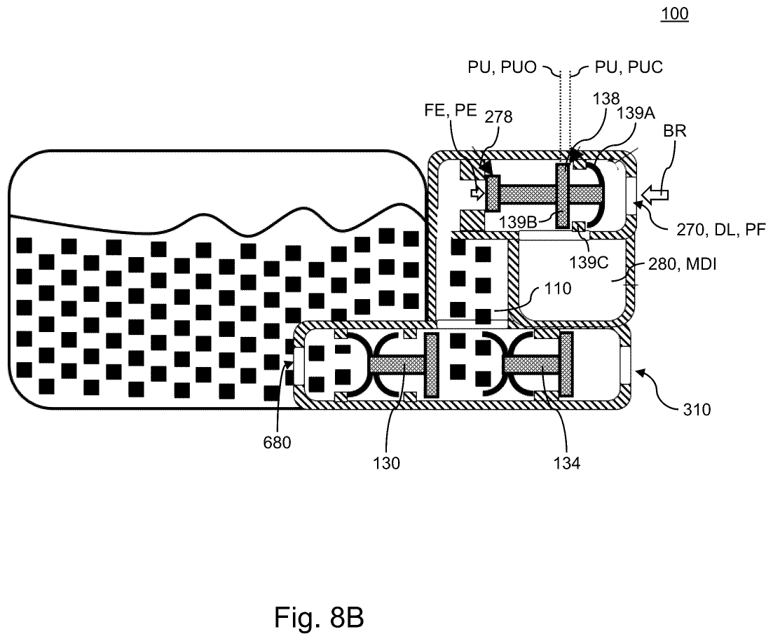

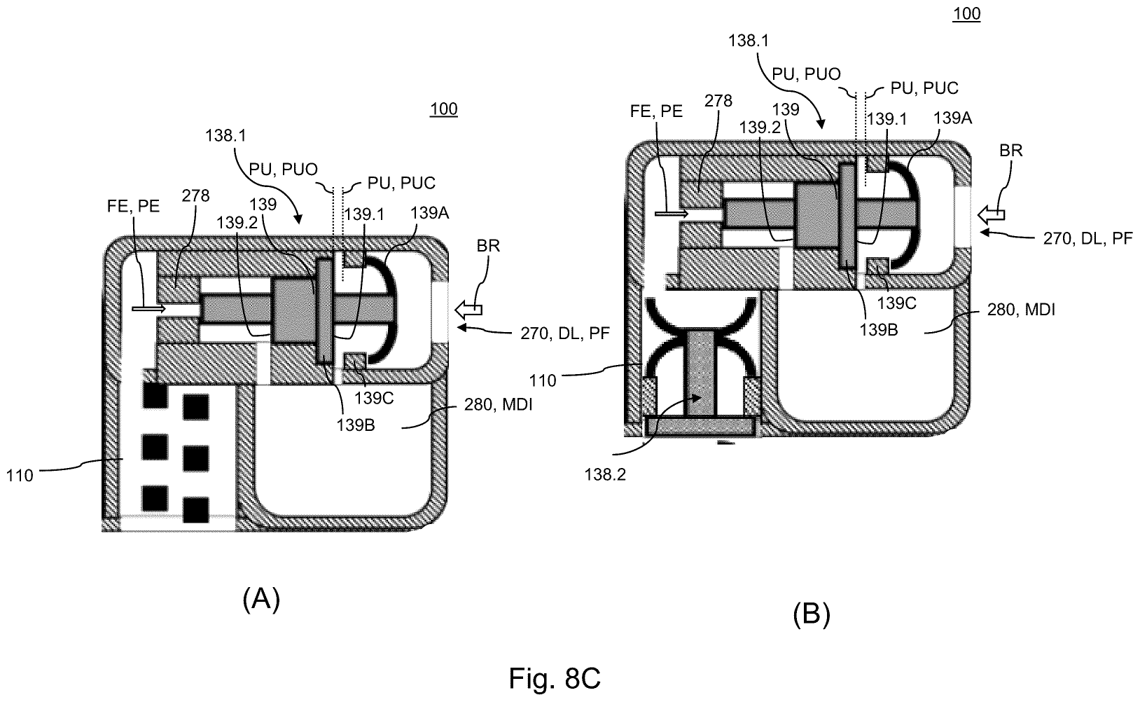

FIG. 8A shows a seventh preferred embodiment of a sensor cleaning device 100, which includes a spring-loaded inlet overflow valve 138 at the pressurized-air inlet 270, a spring-loaded outlet overflow valve 134 at the cleaning port 310, and a spring-loaded inlet non-return valve 130. The arrangement and configuration of the outlet overflow valve 134 and of the inlet non-return valve 130 thus correspond substantially to the arrangement of the third embodiment shown in FIG. 4.

Via a spring-loaded inlet overflow valve 138, it is advantageously achieved that a pressurized air DL provided at the pressurized-air inlet 270 is directed into the conveyed-volume region 110, for the purpose of being applied to a sensor surface 301, only when the conveying pressure PU exceeds a determined minimum value, in particular an inlet overflow pressure PE. Pressurized-air flows, in particular venting flows of a lower pressure, that in particular would not be effective for cleaning, are thus advantageously of no effect for actuation of the sensor cleaning device 100.

FIG. 8B shows an eighth preferred embodiment of a sensor cleaning device 100 which, in contrast to the seventh embodiment shown in FIG. 8A, additionally has a shut-off valve seat 278 at the inlet overflow valve 138, and in which furthermore there is a pressure chamber 280, for accommodating a pressurized-air pulse quantity MDI, arranged between the inlet overflow valve seat 139C and the shut-off valve seat 278.

If the conveying pressure PF exceeds an inlet overflow pressure PE, an inlet valve body 139B lifts off from the inlet valve seat 139C, and moves from a closed inlet overflow-valve position PUC to an open inlet overflow-valve position PUO, and pressurized air DL can flow into the pressure chamber 280. In the open inlet overflow-valve position PUO, the inlet valve body 139B rests on the shut-off valve seat 278 and thus prevents the pressurized air DL from being able to flow into the conveyed-volume region 110. If the conveying pressure PF falls back below the inlet overflow pressure PE, the inlet valve body 139B moves back into the closed inlet overflow-valve position PUC, and the pressurized-air pulse quantity MDI flows through the reopened shut-off valve seat 278 into the conveyed-volume region 110, to be applied to the conveyed quantity MF of the liquid F in a known manner. Advantageously, the pressure chamber 280 and the conveyed-volume region 110 are dimensioned in such a way that, via a resulting pressurized-air pulse quantity MDI, the liquid present in the conveyed-volume region 110 can be displaced substantially completely, that is, conveyed to the cleaning port 310. The inlet overflow pressure PE is preferably 6 bar, such that the inlet overflow valve 138 opens at a conveying pressure PF of greater than or equal to 6 bar. In other embodiments, the inlet overflow pressure PE may be a different value, in particular in the range of from 2 to 12 bar, preferably from 4 to 8 bar, particularly preferably from 5 to 7 bar.

FIG. 8C shows, for a ninth preferred and varied embodiment of a sensor cleaning device 100 according to the concept of the disclosure, a first and a second further variant of an inlet overflow valve 138 in combination with the partially adapted pressure chamber 280 and the conveyed-volume region 110, and otherwise the same configuration as for the eighth preferred embodiment according to FIG. 8B. In this case, the ninth preferred and varied embodiment of the sensor cleaning device 100 is varied, in particular, with respect to the aspects shown in FIG. 8C. In the following, reference is only made specifically to these, it being understood that the description of FIG. 8B applies equally to the other parts of the sensor cleaning device 100 of the ninth preferred and varied embodiment. Further, merely for simplicity, parts that are the same or similar, or those that have the same or similar function, are denoted by the same reference designations.

FIG. 8C again shows a sensor cleaning device 100; this time with a varied inlet overflow valve 138.1 with a shut-off valve seat 278 in view (A) of FIG. 8C, and the varied inlet overflow valve 138.1 with a shut-off valve seat 278 and a further inlet overflow valve 138.2 in view (B) of FIG. 8C.

Compared to the embodiment of the sensor cleaning device 100 having the inlet overflow valve 138 as shown in FIG. 8B, the inlet overflow valve 138.1 of FIG. 8C in both variants of view (A) and view (B) has an adapted piston 139 of the inlet overflow valve 138.1. With reference to the variant of the inlet overflow valve 138.1 shown in the first view (A) of FIG. 8C, it can be seen that the adapted piston 139 of the inlet overflow valve 138.1, having the shut-off valve seat 278, is adapted geometrically. Namely, in such a way that the first piston surface 139.1, located on the side of the piston 139 that faces toward the pressurized-air inlet 270, is larger than the second piston surface 139.2, located on the side of the piston 139 that faces away from the pressurized-air inlet 270.

This adaptation serves to ensure that, following a pressure equalization—that is, following a filling of the pressure chamber 280 with pressurized air from the pressurized-air inlet 270—the piston 139 is held in the open inlet overflow-valve position PUO—as shown in FIG. 8C in view (A) and view (B)—due to the pressure forces and surface ratios with respect to the first piston surface 139.1 and second piston surface 139.2. In particular, this advantageously avoids potential oscillation of the piston 139. Although in principle this is rather unlikely, it may not be completely ruled out, because of undefined or unexpectedly fluctuating force ratios due to the pressure forces and surface area ratios, such as, for instance, in the embodiment of FIG. 8B. The embodiment of the inlet overflow valve 138.1, having the shut-off valve seat 278, in FIG. 8C ensures that the piston 139 is held in the open inlet overflow-valve position PUO—as shown in FIG. 8C in view (A) and view (B)—due to the pressure forces and surface area ratios with respect to the first piston surface 139.1 and second piston surface 139.2, even in the case of undefined or unexpectedly fluctuating force ratios on the piston 139.

In the second variant of the sensor cleaning device 100 shown in view (B) of FIG. 8C, an arrangement of an inlet overflow valve 138 is provided, namely including the previously explained inlet overflow valve 138.1, having the shut-off valve seat 278, according to the first view (A) of FIG. 8C, and a further inlet overflow valve 138.2. The further inlet overflow valve 138.2 is arranged between the pressure chamber 280 and the conveyed-volume region 110, in particular here in the conveyed-volume region 110. This further inlet overflow valve 138.2 prevents the cleaning liquid from flowing into the pressure chamber 280.

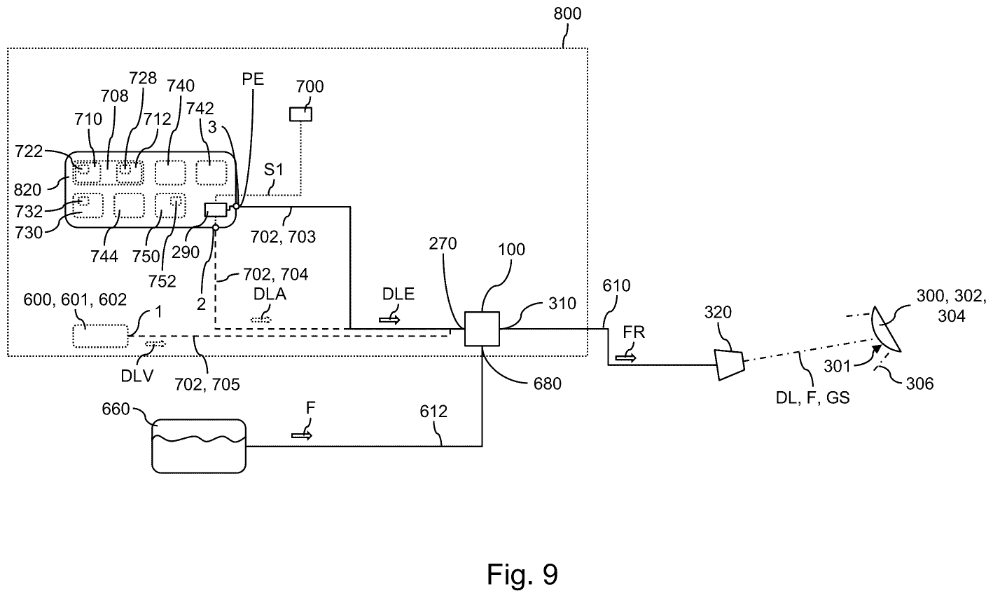

Shown schematically in FIG. 9 is a preferred embodiment of a pneumatic system 800 having a sensor cleaning device 100 according to the concept of the disclosure. The pneumatic system 800 has at least one pressurized-air consumer 820 that is connected to the pressurized-air inlet 270 of the sensor cleaning device 100 via a pressurized-air supply line 702 for the purpose of providing a pressurized air DL.

In particular, the pressurized-air supply line 702 may be realized as a vent line 703, as shown here, which is connected to a vent port 3 of the pressurized-air consumer 820 for the purpose of providing a vent pressurized air DLE. Alternatively or additionally, the pressurized-air inlet 270 may be pneumatically connected to a working port 2 of the pressurized-air consumer 820 via a pressurized-air supply line 702 realized as a working pressurized-air line 704, for the purpose of providing a working pressurized air DLA, as indicated here by a dashed line. Likewise alternatively or additionally, the pressurized-air inlet 270 may be pneumatically connected to a reservoir port 1 of a pressurized-air source 600, for example a pressurized-air reservoir container 601 and/or a compressor 602, via a pressurized-air supply line 702 realized as a reservoir pressurized-air line 705, for the purpose of providing a reservoir pressurized air DLV, as indicated here by a dashed line.

The pressurized-air consumer 820 may be realized, as indicated here by a dashed line, as an air suspension system 730 having at least one air spring 732, or as a brake system 708, in particular a parking-brake system 710 having at least one parking-brake cylinder 722, and/or a service-brake system 712 having at least one service-brake cylinder 728, or as a pneumatic steering-axle lock 740 or as an immobilizer 742 or as a container locking system 744 or as a lift axle 750 having at least one lifting bellows 752. Other pressurized-air consumers 820 or a combination of the aforementioned pressurized-air consumers 820, with each other or with further pressurized-air consumers 820, are also possible.

The pressurized-air consumer 820 has a solenoid switching valve 290 that can be controlled electrically in dependence on an electrical switching signal S1, for the purpose of providing the pressurized air DL at the pressurized-air inlet 270 in a controllable manner.

A liquid reservoir tank 660 is connected to a liquid inlet 680 of the sensor cleaning device 100 via a liquid supply line 612. In other embodiments, as shown previously, the sensor cleaning device 100 may also be arranged partially or completely within and/or integrally connected to the liquid supply tank 660. Via a cleaning port 310, at least one cleaning nozzle 320 is fluidically connected to the sensor cleaning device 100 in order to receive a pressurized air DL and/or a liquid F and/or a spray mixture GS and to direct this/these onto a sensor surface 301 of a sensor 300 for the purpose of cleaning. The sensor 300 is preferably realized as an optical sensor 302, particularly preferably as a camera 304, as shown here.

Preferably, the provision of the pressurized air at the cleaning port 310 may be effected upon request by the vehicle driver or the system. Initiation of the cleaning process can thus be achieved particularly easily. For example, this may involve an action such as applying the brake to provide pressurized air, or release of pressurized air by the system.

Thus, in a preferred embodiment, for example as a result of a (full) actuation of a pressurized-air consumer, a portion of its working air may be used as pressurized air DL of the cleaning system, or the cleaning may be initiated, for example, by full actuation of the brake, by (brief) activation of a lifting bellows of a lift axle, et cetera.

Cleaning can be initiated comparatively easily by simply “fully applying the brake”. In particular, it is evident that this can take place without further communication between a tractor vehicle and a trailer (truck/trailer) of the vehicle 1000, and that it can be conveniently controlled by the driver.

Technically, the brake pressure may theoretically be used, for example, directly as pressurized air or, alternatively, the brake pressure from the trailer may be sensed via an electronic brake system (EBS system). The latter could recognize the full application of the brake by the driver as a request, initiate a cleaning operation and, in turn, activate the corresponding pressurized-air valve that is connected to the pressurized-air inlet 270.

It is understood that the foregoing description is that of the preferred embodiments of the invention and that various changes and modifications may be made thereto without departing from the spirit and scope of the invention as defined in the appended claims.

### LIST OF REFERENCE DESIGNATIONS (PART OF THE DESCRIPTION)

1 reservoir port
2 working port
3 vent port
100 sensor cleaning device
110 conveyed-volume region
112 container wall
113 conveying chamber
114 end of the conveyed-volume region
114A first end of the conveyed-volume region
114B second end of the conveyed-volume region
116 immersion tube
116A immersion-tube orifice
117 immersion-tube port
118 conveying passage
119A first side of the conveying passage
119B second side of the conveying passage
130 inlet non-return valve
131A liquid-inlet valve spring
131B liquid-inlet valve body
131C liquid-inlet valve seat
134 outlet overflow valve
135A outlet valve spring
135B outlet valve body
135C outlet valve seat
138 inlet overflow valve
138.1, 138.2 variant inlet overflow valve, further inlet overflow valve
139 piston of the varied inlet overflow valve
139.1 first piston surface, located on the side that faces toward the pressurized-air inlet 270
139.2 second piston surface, located on the side that faces away from the pressurized-air inlet 270
139A inlet valve spring
139B inlet valve body
139C inlet valve seat
270 pressurized-air inlet
272 pressurized-air branch
278 shut-off valve seat
280 pressure chamber
290 solenoid switching valve
294 fill-level sensor
300 sensor
301 sensor surface
302 optical sensor
304 camera
310 cleaning port
320 cleaning nozzle
600 pressurized-air source
601 pressurized-air reservoir container
602 compressor
610 nozzle line
612 liquid supply line
660 liquid reservoir tank
669 tank wall
670 lower region of the liquid reservoir tank
672 upper region of the liquid reservoir tank
680 liquid inlet
700 electronic control unit
702 pressurized-air supply line
703 vent line
704 working pressurized-air line
705 reservoir pressurized-air line
707 electric line
708 brake system
710 parking-brake system
712 service-brake system
722 parking-brake cylinder
728 service-brake cylinder
730 air suspension system
732 air springs
734 air-spring valve
740 steering-axle lock
742 immobilizer
744 container locking system
750 lift axle
752 lifting bellows
800 pneumatic system
820 pressurized-air consumer
1000 vehicle
1006 trailer
1007 rear region
A longitudinal axis
AF conveying distance
AL longitudinal axis
AQ cross-sectional area
BR pressurization direction
DL pressurized air
DLA working pressurized air
DLD throttling air flow
DLE vent pressurized air
DLV reservoir pressurized air
F liquid
FE inlet spring force
FEF liquid-inlet spring force
FR conveying direction
FS outlet spring force
G gravity
GS spray mixture
HF fill height
HFM maximum fill height
HFZ conveying height
HT tank height
MDI pressurized-air pulse quantity
MF conveyed quantity
PE inlet overflow pressure
PF conveying pressure
PU outlet overflow pressure
PUC inlet overflow-valve position
PUO inlet overflow-valve position
S1 electrical switching signal, electronic switching signal
S2 electrical fill-level signal, electronic fill-level signal
U environment

1. A sensor cleaning device for a vehicle, the sensor cleaning device being for cleaning at least one sensor surface of a sensor, the sensor cleaning device comprising:
a pressurized-air inlet for receiving pressurized air;
a liquid inlet for receiving liquid;
a cleaning port configured to provide at least one of the liquid and the pressurized air; and,
a conveyed-volume region configured to accommodate the liquid and which is fluidically connected to said pressurized-air inlet, said liquid inlet, and said cleaning port such that the liquid is conveyed in a conveying direction to said cleaning port as a result of the pressurized air being applied to said pressurized-air inlet, wherein said conveyed-volume region is realized such that, for conveying the liquid, the pressurized air is in contact with the liquid.

2. The sensor cleaning device of claim 1, wherein the pressurized air is in contact with the fluid at least one of directly and in a pressure-transmitting manner realizing a phase boundary.

3. The sensor cleaning device of claim 1, wherein:
said conveyed-volume region is configured to accommodate a conveyed quantity of the liquid; and,
said conveyed quantity is conveyed to said cleaning port in the conveying direction as a result of the pressurized air being applied to said pressurized-air inlet.

4. The sensor cleaning device of claim 1 further comprising a pneumatic separator arranged at said liquid inlet of said conveyed-volume region and opening in the conveying direction and shutting off counter to the conveying direction.

5. The sensor cleaning device of claim 1 further comprising an inlet non-return separator arranged at said liquid inlet of said conveyed-volume region and opening in the conveying direction and shutting off counter to the conveying direction.

6. The sensor cleaning device of claim 1 further comprising an outlet overflow valve arranged at said cleaning port of said conveyed-volume region and opening in the conveying direction and shutting off counter to the conveying direction.

7. The sensor cleaning device of claim 1 further comprising an outlet overflow valve arranged at said cleaning port of said conveyed-volume region and opening in the conveying direction against an outlet spring force of a valve spring and shutting off counter to the conveying direction.

8. The sensor cleaning device of claim 1 further comprising an inlet overflow valve arranged at said pressurized-air inlet of said conveyed-volume region and opening in a direction of a pressurization direction of the pressurized air and shutting off counter to the pressurization direction.

9. The sensor cleaning device of claim 8, wherein said inlet overflow valve is spring-loaded.

10. The sensor cleaning device of claim 1 further comprising:
a pressure chamber;
said pressurized-air inlet having a shut-off valve seat configured to be closed by an inlet overflow valve in dependence on an inlet overflow-valve position;
said pressure chamber being pneumatically connected between the inlet overflow valve and said shut-off valve seat; and,
said pressure chamber being configured to accommodate a pressurized-air pulse quantity from said pressurized-air inlet when said inlet overflow valve is in an open inlet overflow-valve position, and to provide the pressurized-air pulse quantity, via said shut-off valve seat, to the conveyed-volume region when said overflow valve is in a closed overflow-valve position.

11. The sensor cleaning device of claim 1, wherein at least one of:
said conveyed-volume region is pneumatically decoupled from a storage region, by a pneumatic separator at said liquid inlet;
said storage region is or is configured to be fluidically connected to said liquid inlet;
said storage region is a liquid reservoir tank; and,
said pneumatic separator is an inlet non-return valve.

12. The sensor cleaning device of claim 11, wherein said conveyed-volume region is formed distally from said storage region, downstream of said separator at said liquid inlet.

13. The sensor cleaning device of claim 11, wherein said conveyed-volume region is arranged in the liquid reservoir tank or projecting into the liquid reservoir tank.

14. The sensor cleaning device of claim 13, wherein said liquid inlet is arranged in a lower region of said liquid reservoir tank.

15. The sensor cleaning device of claim 11, wherein at least one of said pressurized-air inlet and a pressurized-air branch is arranged in or on the liquid reservoir tank; and, said liquid inlet is arranged in or on the conveyed-volume region.

16. The sensor cleaning device of claim 15, wherein at least one of:
said at least one of said pressurized-air inlet and said pressurized-air branch is arranged in a tank wall; and,
said liquid inlet is arranged in a container wall.

17. The sensor cleaning device of claim 1, wherein at least one of said pressurized-air inlet, said liquid inlet, and said cleaning port is arranged at or in said conveyed-volume region.

18. The sensor cleaning device of claim 1, wherein said pressurized-air inlet is arranged, with respect to at least one of the conveying direction and a longitudinal axis of said conveyed-volume region, at a conveying distance from said cleaning port.

19. The sensor cleaning device of claim 1, wherein said pressurized-air inlet is arranged, with respect to at least one of the conveying direction and a longitudinal axis of said conveyed-volume region, at a conveying distance from said cleaning port opposite to said cleaning port with respect to at least one of said conveyed-volume region and the conveying direction.

20. The sensor cleaning device of claim 6 further comprising an inlet non-return separator arranged at said liquid inlet of said conveyed-volume region and opening in the conveying direction and shutting off counter to the conveying direction, wherein at least one of:
said outlet overflow valve is spaced apart from said inlet non-return valve at a conveying height, in a direction of gravity; and,
a solenoid switching valve, arranged at said pressurized-air inlet, is configured for controllable pressurization of the pressurized-air inlet.

21. The sensor cleaning device of claim 1 further comprising at least one of:
an adapted inlet overflow valve including an adapted piston assigned to a shut-off valve seat, wherein a first piston surface, located on a side of the piston facing toward said pressurized-air inlet, is larger than a second piston surface, located on a side of the piston facing away from said pressurized-air inlet; and,
an arrangement including at least one of an inlet overflow valve and an adapted inlet overflow valve, having a further inlet overflow valve between a pressure chamber and the conveyed-volume region or in the conveyed-volume region.

22. A pneumatic system for a vehicle, the pneumatic system comprising:
a sensor having a sensor surface;
a sensor cleaning device for cleaning the sensor surface;
said sensor cleaning device including a pressurized-air inlet for receiving pressurized air, a liquid inlet for receiving liquid, and a cleaning port configured to provide at least one of the liquid and the pressurized air; and,
said sensor cleaning device further including a conveyed-volume region configured to accommodate the liquid and which is fluidically connected to said pressurized-air inlet, said liquid inlet, and said cleaning port such that the liquid is conveyed in a conveying direction to said cleaning port as a result of the pressurized air being applied to said pressurized-air inlet, wherein said conveyed-volume region is realized such that, for conveying the liquid, the pressurized air is in contact with the liquid.

23. The pneumatic system of claim 22 further comprising a pressurized-air consumer, wherein at least one of a vent port of the pressurized-air consumer is or is configured to be connected to said pressurized-air inlet for receiving a vent pressurized air as the pressurized air and a working port of said pressurized-air consumer is or is configured to be connected to said pressurized-air inlet for receiving a working pressurized air as the pressurized air.

24. A vehicle comprising:
the sensor cleaning device of claim 1.

25. The vehicle of claim 24, wherein the vehicle is a commercial vehicle, a passenger car, or a trailer.

26. A method for operating a sensor cleaning device for cleaning at least one sensor surface of a sensor, the sensor device including a pressurized-air inlet for receiving pressurized air, a liquid inlet for receiving liquid, a cleaning port configured to provide at least one of the liquid and the pressurized air, and, a conveyed-volume region configured to accommodate the liquid and which is fluidically connected to the pressurized-air inlet, the liquid inlet, and the cleaning port such that the liquid is conveyed in a conveying direction to the cleaning port as a result of the pressurized air being applied to the pressurized-air inlet, wherein the conveyed-volume region is realized such that, for conveying the liquid, the pressurized air is in contact with the liquid, the method comprising:
automatically filling the conveyed-volume region with the liquid from a liquid reservoir tank;
pressurizing the liquid with the pressurized air which is in contact with the liquid; and,
providing the pressurized liquid at the cleaning port.

27. The method of claim 26 further comprising providing the pressurized air at the cleaning port in addition to the pressurized liquid.

28. The method of claim 27, wherein the pressurized air is provided subsequently or simultaneously to said providing the pressurized liquid.

29. The method as claimed in claim 26 further comprising:
directing the liquid onto the sensor surface of the sensor;
determining at least one of:
a wait period that elapses between an activating of a solenoid switching valve for the controlled application of the pressurized air to the liquid, and an impingement of the liquid upon the sensor surface, and,
determining, via the sensor, an application period in which the liquid is applied to the sensor surface; and,
determining a fill height of the liquid in at least one of the liquid reservoir tank and the conveyed-volume region in dependence upon at least one of the wait period and the application period.

30. The method of claim 26 further comprising: controlling a pressurized-air consumer to provide a working pressurized air to the sensor cleaning device for pressurizing the liquid.

31. The method of claim 26 further comprising: actuating the pressurized-air consumer to provide a working pressurized air to the sensor cleaning device at the pressurized-air inlet of the sensor cleaning device for pressurizing the liquid.
